(19) United States
(12) Patent Application Publication
(10) Pub. No.: US 2018/0264344 A1
(43) Pub. Date: Sep. 20, 2018

(54) FITNESS AND ENTERTAINMENT MEDIA PLATFORM METHOD AND SYSTEM

(71) Applicant: FEVIR, LLC, Seattle, WA (US)

(72) Inventors: Adam Michael Garrett Bollinger, Beverly Hills, CA (US); Jamal Everette Liggin, West Hollywood, CA (US)

(21) Appl. No.: 15/880,497

(22) Filed: Jan. 25, 2018

Related U.S. Application Data
(60) Provisional application No. 62/450,522, filed on Jan. 25, 2017.

(51) Int. Cl. A63B 71/06; G09B 5/06; G09B 19/00; H04N 21/472; H04N 21/478; H04N 21/414; H04N 21/433

(52) U.S. Cl. CPC A63B 71/0622; G09B 5/065; G09B 19/0038; H04N 21/472; H04N 21/478; A63B 69/002; H04N 21/4334; A63B 2071/063; A63B 2071/0638; A63B 2071/0647; A63B 2071/065; H04N 21/41407

(57) ABSTRACT

Embodiments are directed to fitness performance training and media and entertainment production and consumption, including, for example, to methods and systems for a subscription-based platform implemented on a mobile device to achieve the needs of performance training and high-quality, sports-related content creation and consumption. This application discloses methods and systems for a combined fitness and entertainment media platform on a mobile device to deliver and curate performance training and entertainment content directly to and for a subscriber through the presentation of a series of microprocessor-executable exercise videos featuring at least one professional person to demonstrate an exercise routine chosen by the subscriber, wherein the series of exercises is specially designed to improve performance in a particular sport, and at least one microprocessor-executable entertainment video featuring the professional person, wherein the entertainment video includes at least a class sports film and original content curated by the professional person.

### PRIORITY CLAIM

This application claims the benefit of U.S. Provisional Patent Application Ser. No. 62/450,522 filed Jan. 25, 2017, which is incorporated by reference in its entirety as if fully set forth herein.

### COPYRIGHT NOTICE

This disclosure is protected under United States and/or International Copyright Laws. © 2018 FeVir, LLC. All Rights Reserved. A portion of the disclosure of this patent document contains material that is subject to copyright protection. The copyright owner has no objection to the facsimile reproduction by anyone of the patent document or the patent disclosure, as it appears in the Patent and/or Trademark Office patent file or records, but otherwise reserves all copyright rights whatsoever.

### BACKGROUND

Most athletes (whether casual, amateur, or professional) who desire high performance in sports often need and desire specific performance training (e.g., strength, agility, and speed) that adequately matches the demands of the particular sport they play. Conventional high caliber personal trainers can provide the necessary training, motivation, and feedback, but are unavailable and unaffordable to most people.

In addition, casual, amateur, or professional athletes may also enjoy watching a variety of professional athletes compete in various sports, for the purpose of either learning or entertainment or both. Aside from watching broadcasted professional competitions, these athletes and other fans of the sport and/or professional athlete tend to follow the personal lives and understand the interests (e.g., charities) of these professional athletes. Not only do some people enjoy watching such sports-related entertainment and content, but a vast majority of people frequently carry their mobile devices are accustomed to having such content on-demand with their instant and continuous connectivity to the Internet and social media.

Accordingly, there is a need for improvement in the field of fitness performance training and media and entertainment production and consumption.

### BRIEF DESCRIPTION OF THE DRAWINGS

FIGS. 1A-1T illustrate an embodiment of the invention.

FIGS. 2A-2H illustrate an embodiment of the invention.

FIGS. 3A-3T illustrate an embodiment of the invention.

FIGS. 4A-1-4F-2 illustrate non-exhaustive examples of different programs in an embodiment of the invention.

FIGS. 5A-5E illustrate an embodiment of the invention.

FIGS. 6A-6B illustrate a system embodiment not using motion, force and physiologic sensors.

FIGS. 7A-7B illustrate a system embodiment using motion, force, and physiologic sensors.

FIG. 8 is a flowchart illustrating a method embodiment not using motion, force and physiologic sensors.

FIG. 9 is a flowchart illustrating a method embodiment using motion, force, and physiologic sensors.

### DETAILED DESCRIPTION OF THE PREFERRED EMBODIMENT

Prior to the present invention, there has been no perceived need for an innovative fitness and entertainment media platform to achieve the needs of fitness and performance training, sports-related content production and consumption, and the social network. Embodiments of the present invention integrate performance training, sports entertainment, content creation and production, and technology to cultivate a new platform for user fitness, athlete expression, media and entertainment, interaction, education, and results. Unlike the prior art, embodiments of the present invention can offer a one-stop shop for fitness and sports fans for their optimal performance training, licensed sports-related broadcasts and content, and other original content with close and personal behind-the-scenes access to celebrities, athletes, and the like.

For example, conventional gym routines and home or online exercise videos may be accessible, but can become repetitive and boring. As the name suggests, “home” exercise videos or “gym” routines may not be in line with the mobile lives of the modern person, even when these videos and routines can be pre-recorded or even live streamed. Moreover, there may be uncertainty about whether the user is performing the exercises properly or improving their fitness and/or performance through participation in the workouts. Conventional fitness tracking devices or other wearable technology may provide limited feedback to and accountability for the user, but cannot provide fitness or performance training.

In contrast, embodiments of the present invention are capable of delivering fresh workout content on a regular basis on, for example, a mobile device, and unlike the prior art, embodiments of the present invention can offer a combination of indoor and outdoor workouts as part of any one program. Moreover, the content can be delivered via high profile professional athletes from a variety of sports and allows for optimal performance training directly to the user at a reasonable price.

For example, in a preferred embodiment of the present invention, users have the opportunity to achieve their athletic goals and learn from professional athletes and their trainers on how to train on a day-to-day basis, often using the very workout schedules and routines curated for the professional athletes that enable them to perform at such high levels in their respective sports, through high production value, Hollywood-quality videos in an affordable and accessible manner through an application on their mobile device. In this preferred embodiment, the user is also able to access and consume original entertainment content (e.g., inspirational interviews, hosted charity events, new product sneak peeks) as well as other sports-related entertainment (e.g., sports match, sports movies, sports television shows, sports-related games) from this mobile application. Additionally, in this preferred embodiment, the athlete is able to leverage mobile content and social media to connect with others (e.g., fans), build their brands as well as the brands of their sponsors, raise awareness on issues that are important to them (e.g., charities), and gain support in a variety of areas.

Embodiments of the present invention, either independently or working together, as more fully described below, act as a new sports media platform unmet by conventional applications that can be utilized in different industries and disciplines—not just in professional sports—including but not limited to apparel, fitness, sports, interactive media, entertainment, equipment, braces, and supports. For example, equipment can include the modification of cellphone straps that enable the user to wear the cellphone on the forearm, much like a quarterback sleeve. This would allow for easier viewing of content. In other embodiments, equipment can also include but not be limited to exercise bands, ladders, hurdles, etc. Additionally, equipment can also include but not be limited to wearable technology like heart rate monitors, watches, and other forms of biometric monitoring. Braces and supports, like other apparel or equipment, can also be incorporated. For example, a knee brace the user wears can provide for additional support during performance driven activity.

Compared to the status quo of fitness training and/or sports media, for example, the specific combinations of the particular elements in the present invention can greatly enhance the convenience and daily lives of mobile device users as well as athletes and businesses which have mobile device users as part of their target audience/market. As such, the present invention is unique in that it results in a solution that solves a problem that previously has not been perceived or entertained by consumers, production studios, entertainment companies, business owners, athletes, or developers. Embodiments of the present invention will provide unexpected convenience and benefits to all.

This application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of the present invention.

Embodiments of the present invention may comprise or utilize a special-purpose or general-purpose computer including computer hardware, such as, for example, one or more processors and system memory, as discussed in greater detail below. Embodiments within the scope of the present invention also include physical and other computer-readable media for carrying or storing computer-executable instructions or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special-purpose computer system. Computer-readable media that store computer-executable instructions are non-transitory computer-readable storage media (devices). Computer-readable media that carry computer-executable instructions are transmission media. Thus, by way of example, and not limitation, embodiments of the invention can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special-purpose computer.

A “network” is defined as one or more data links that enable the transport of electronic data between computer systems or modules or other electronic devices. When information is transferred or provided over a network or another communications connection (either hardwired, wireless, or a combination of hardwired or wireless) to a computer, the computer properly views the connection as a transmission medium. Transmissions media can include a network or data links which can be used to carry desired program code means in the form of computer-executable instructions or data structures and which can be accessed by a general purpose or special-purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special-purpose computer, or special-purpose processing device to perform a certain function or group of functions. In some embodiments, computer-executable instructions are executed on a general-purpose computer to turn the general-purpose computer into a special-purpose computer implementing elements of the invention. The computer executable instructions may be, for example, binaries, intermediate format instructions such as assembly language, or even source code.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

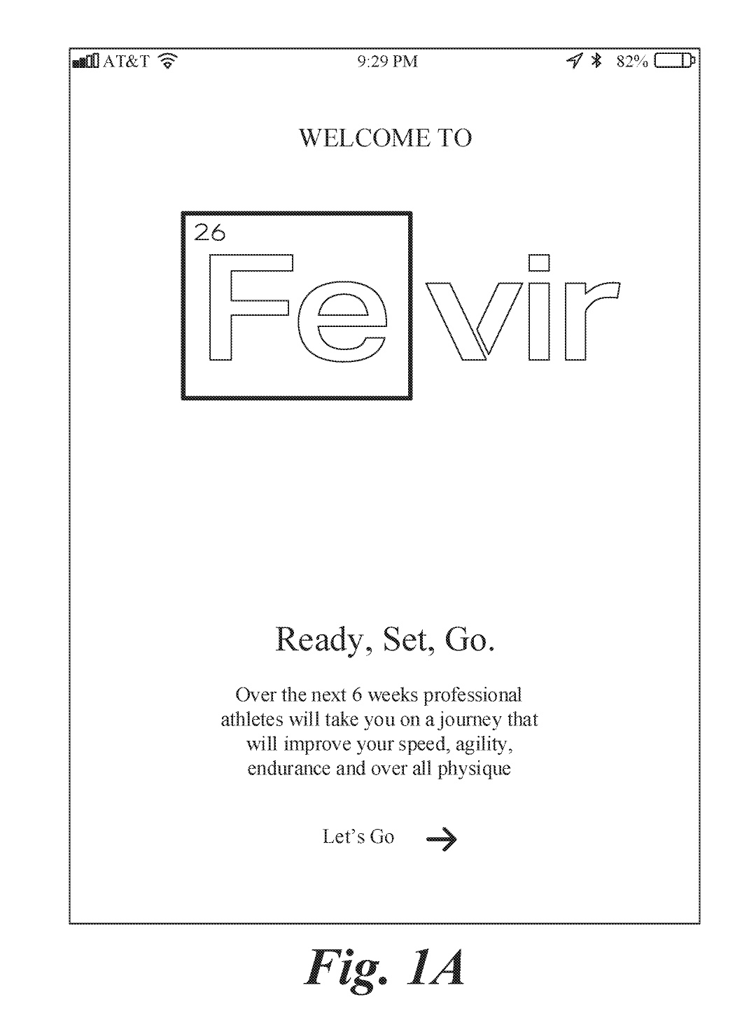

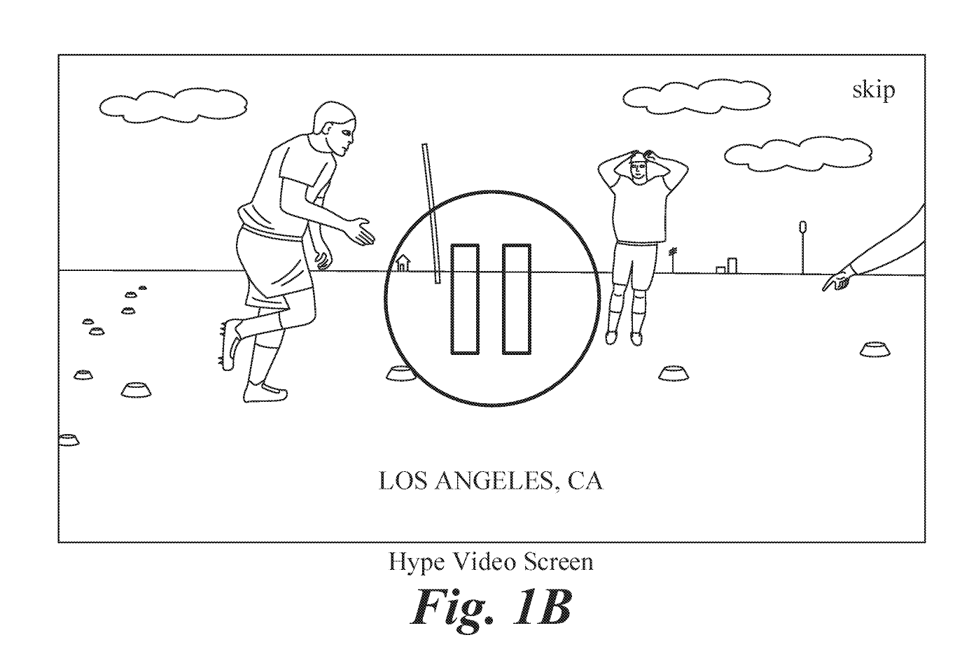

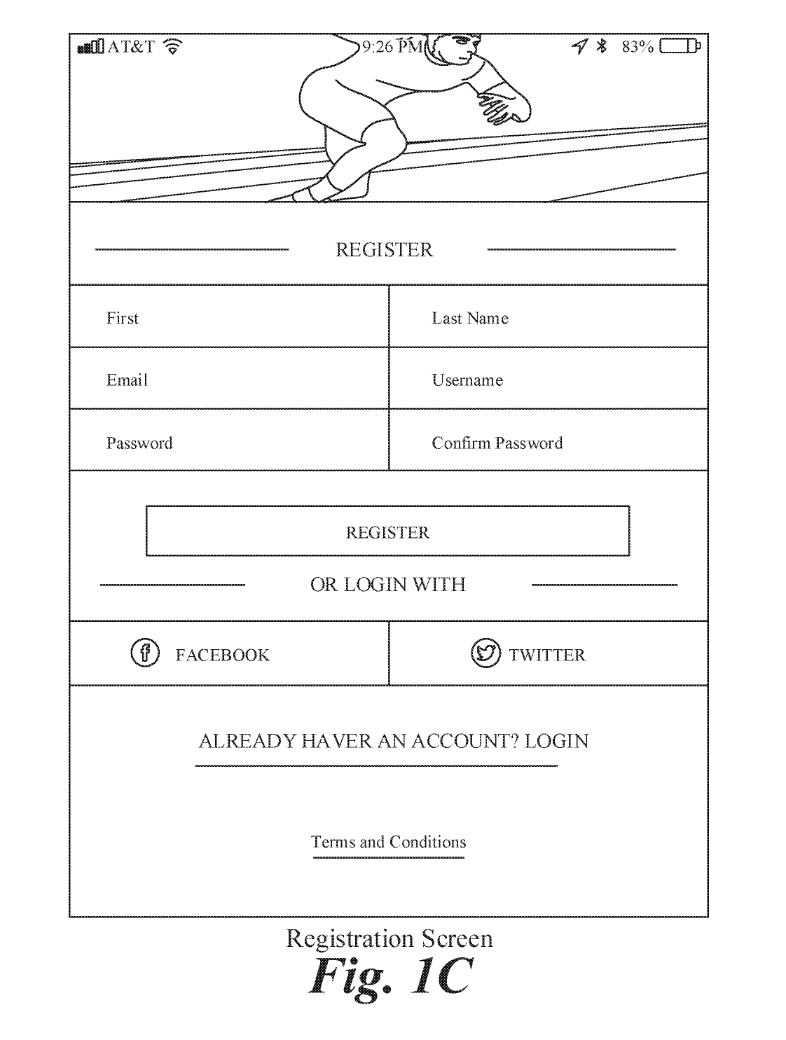

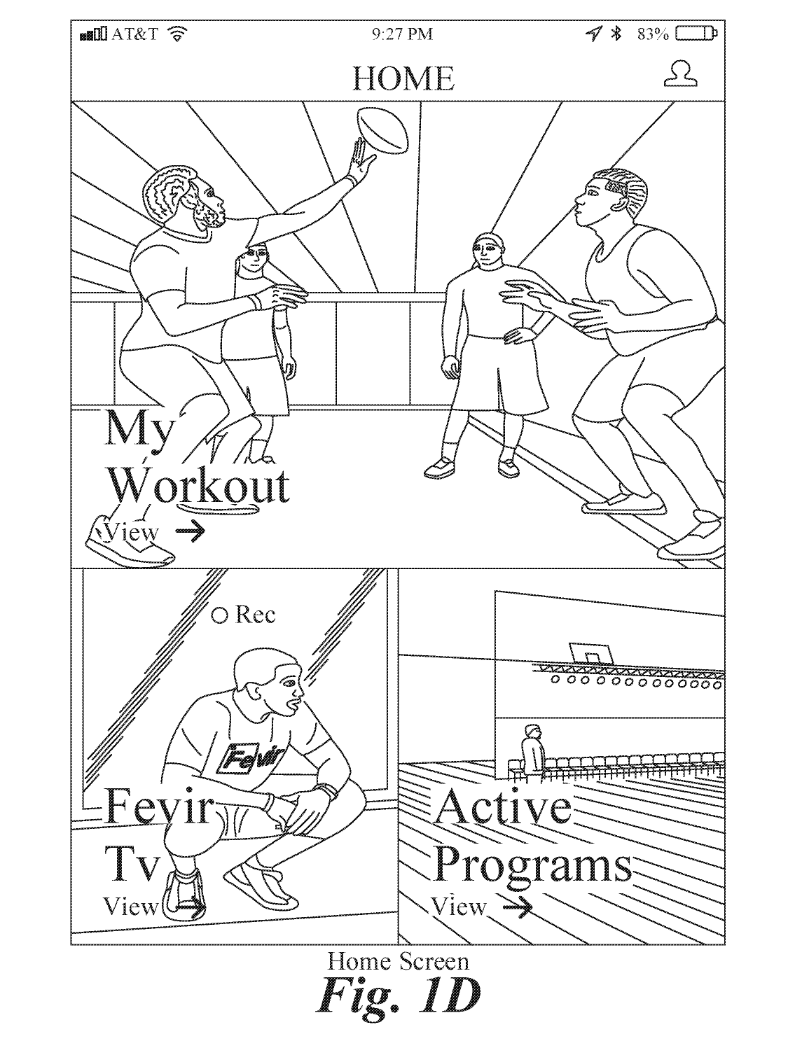

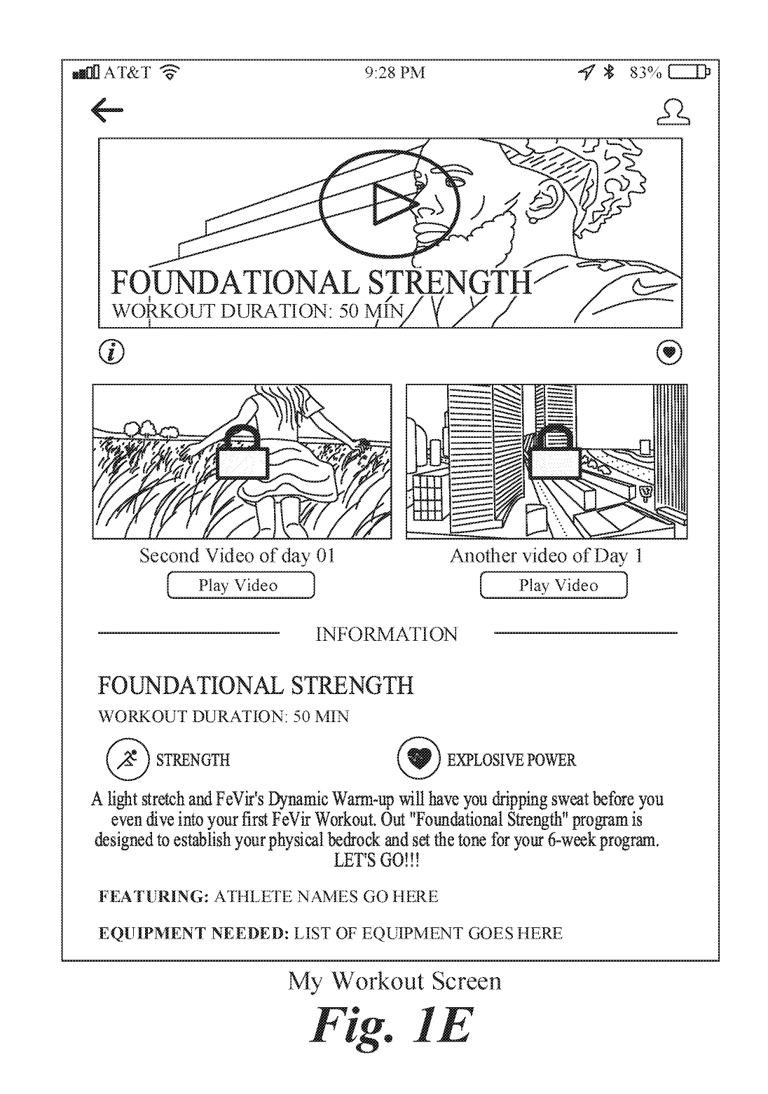

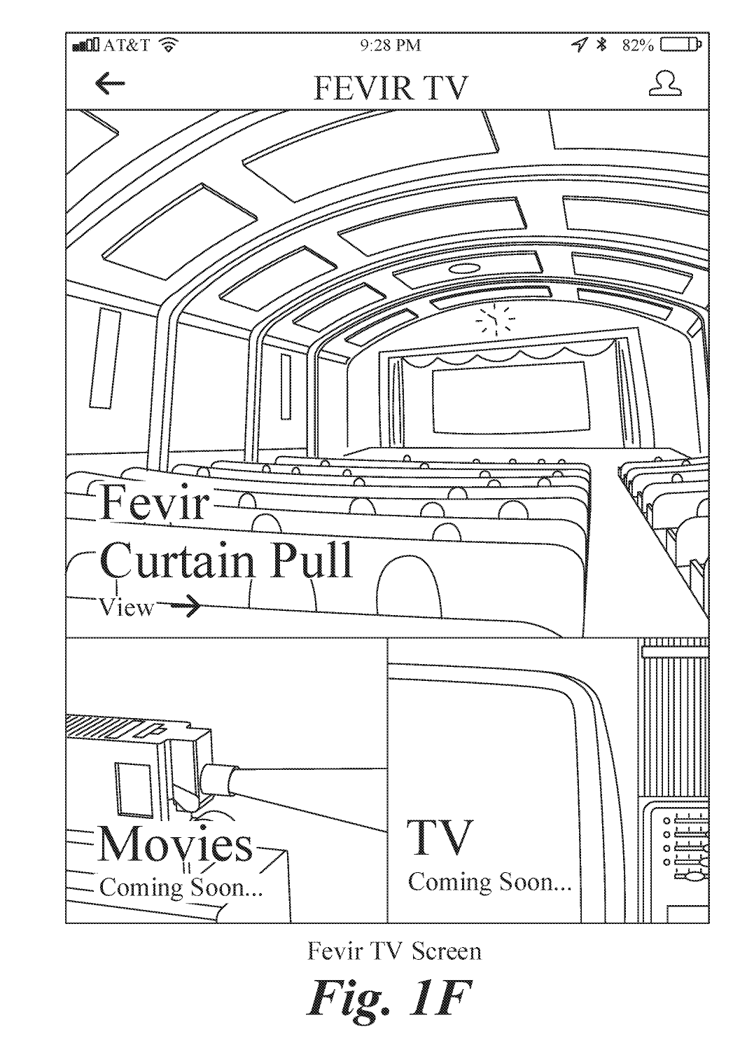

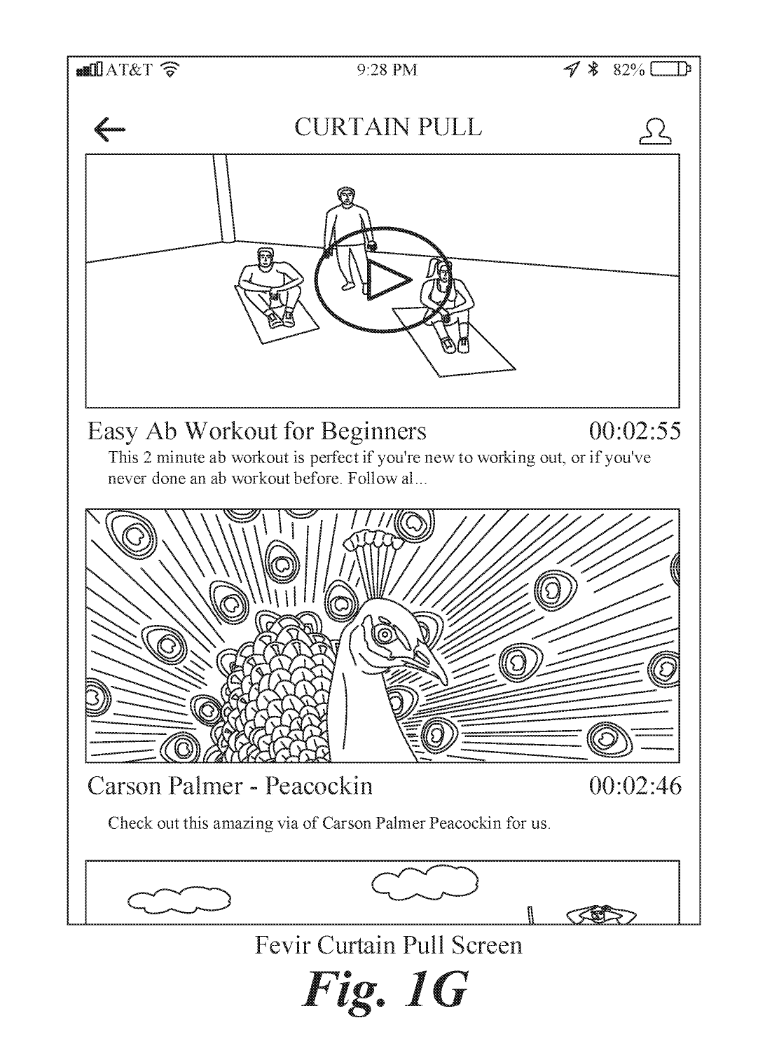

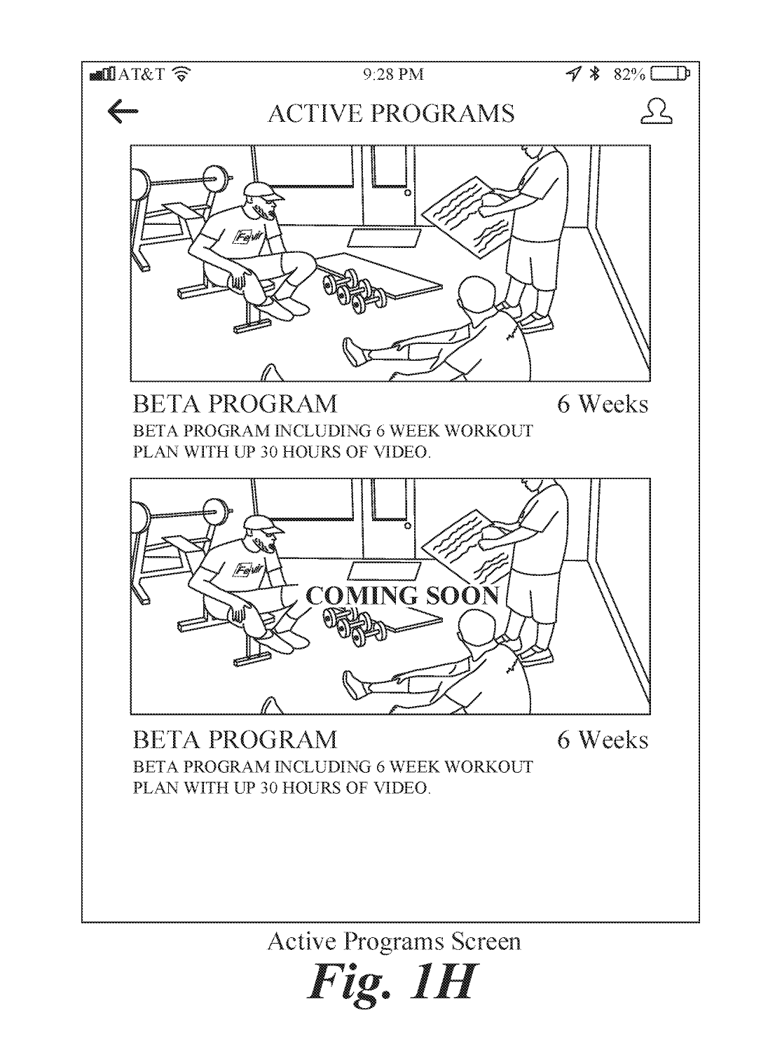

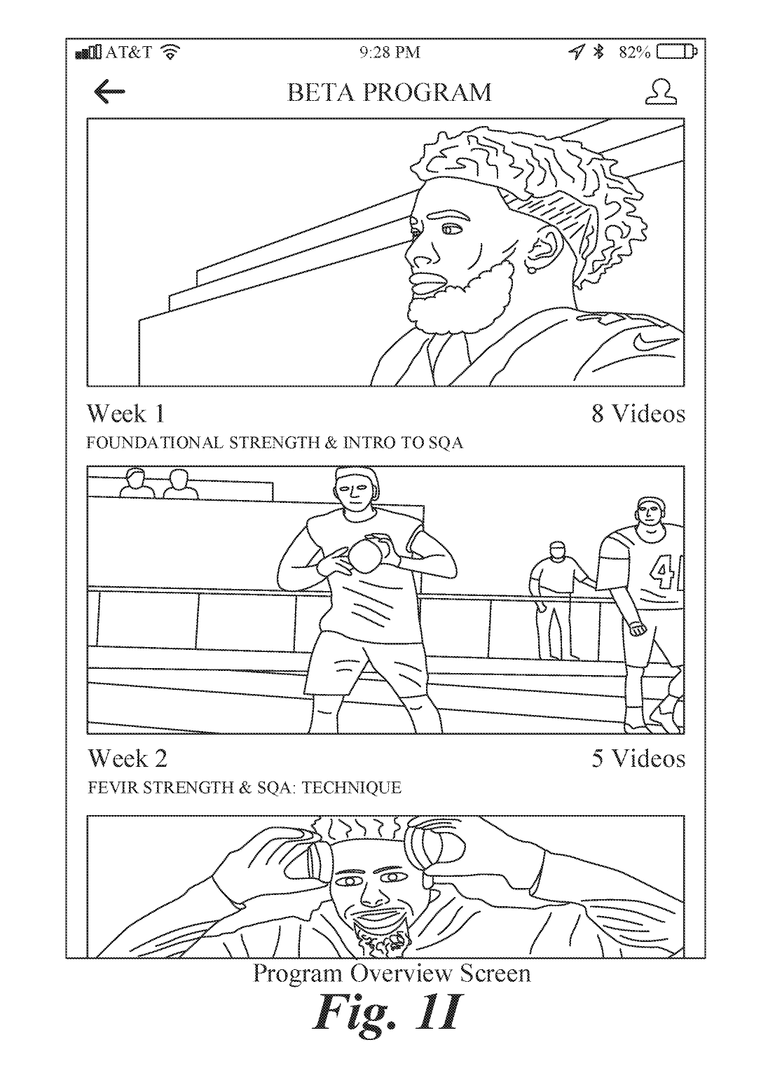

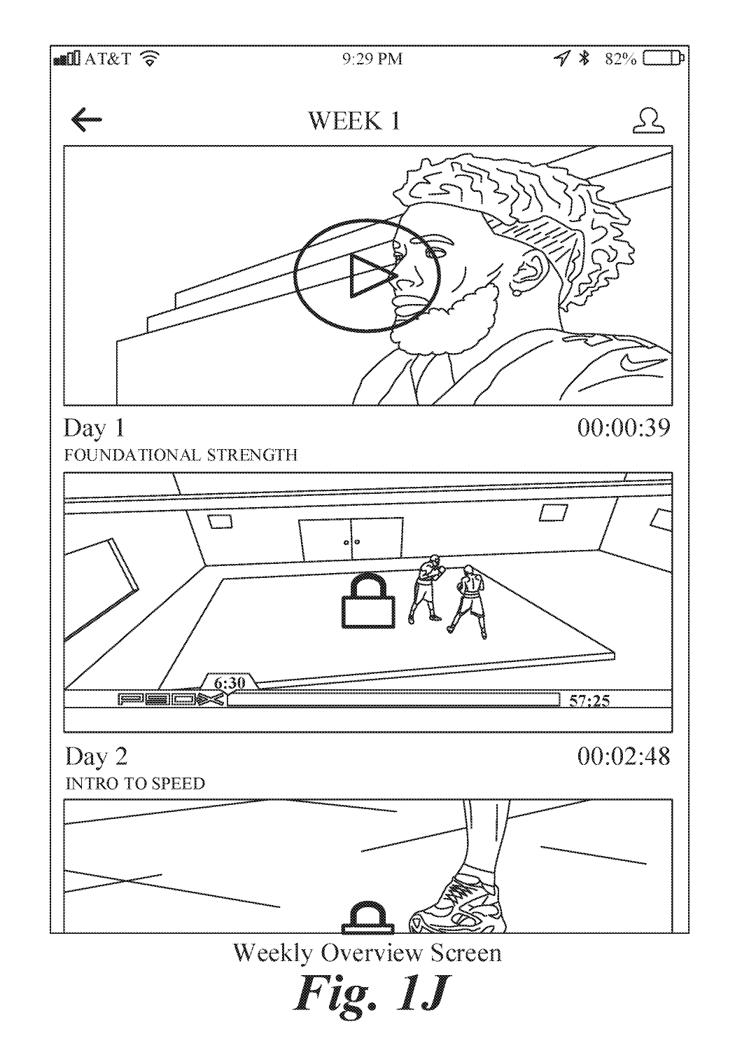

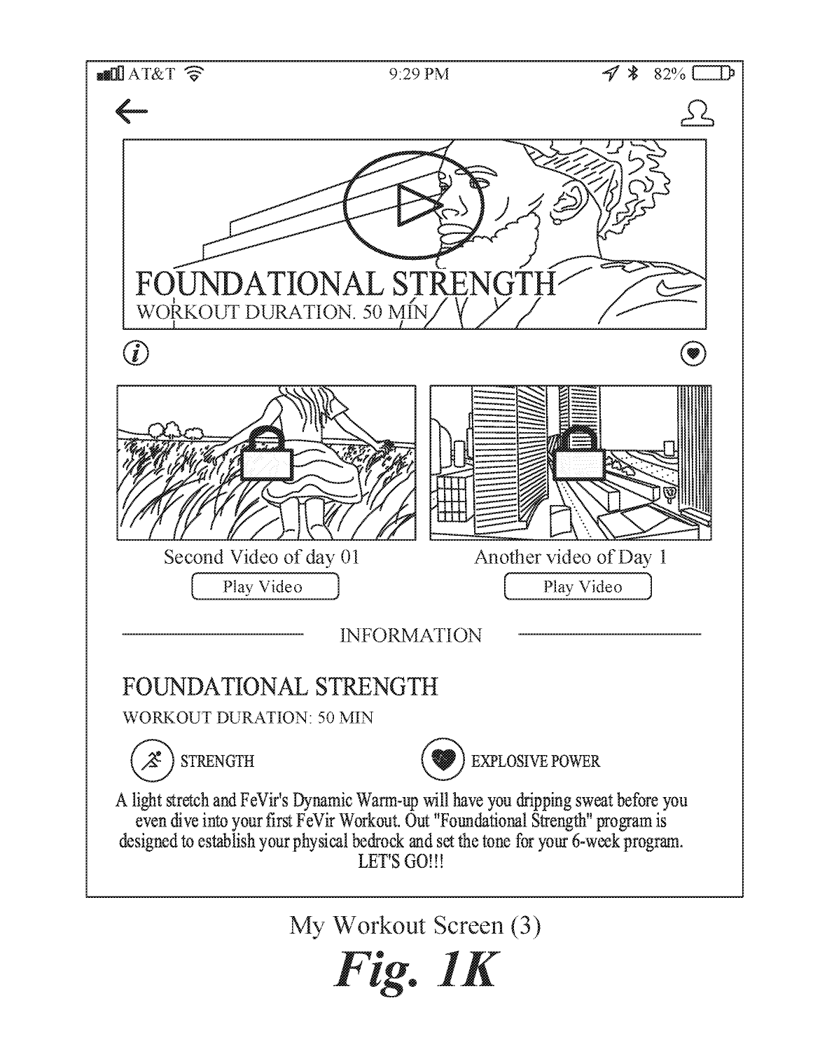

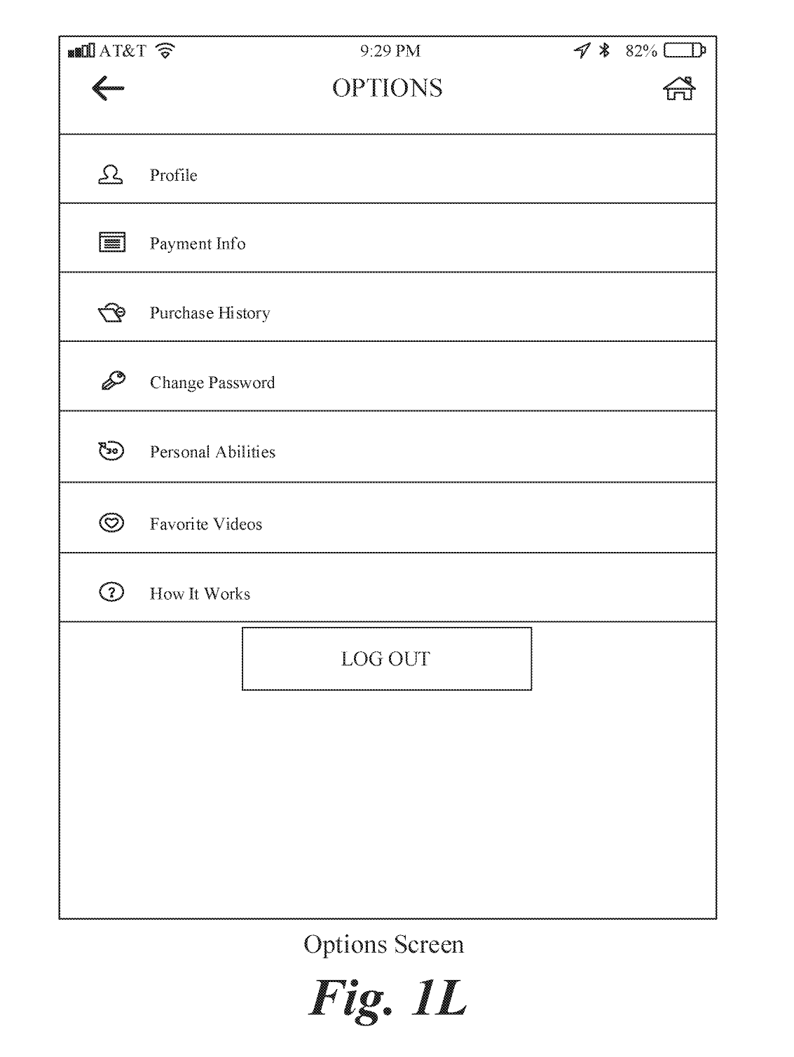

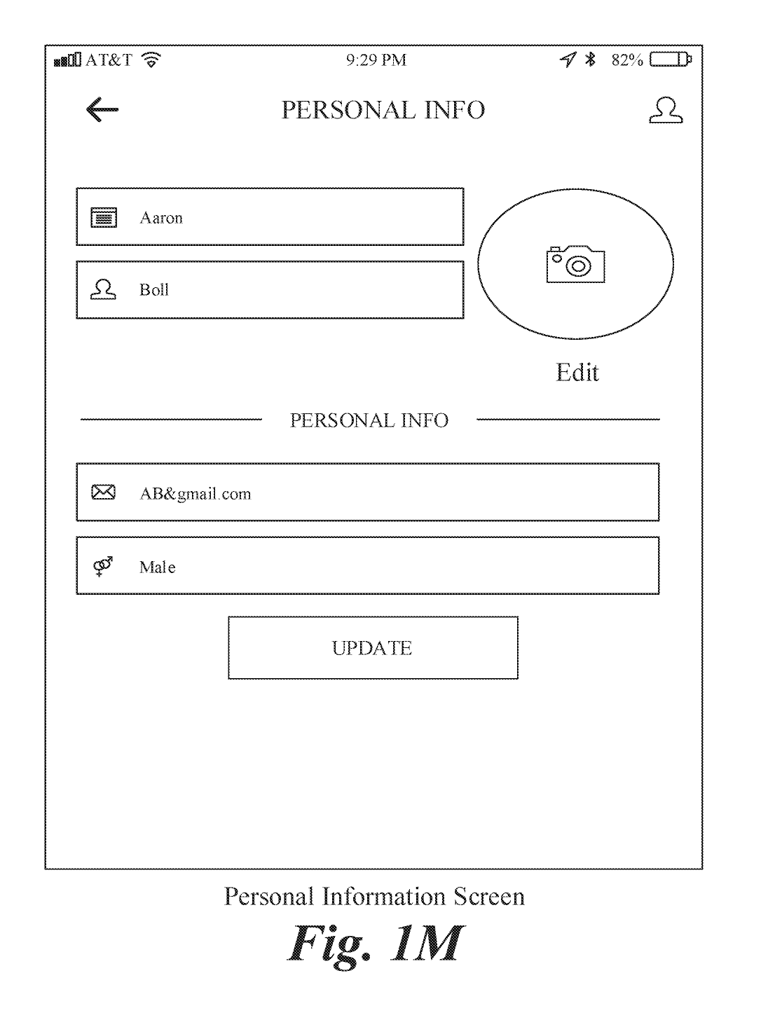

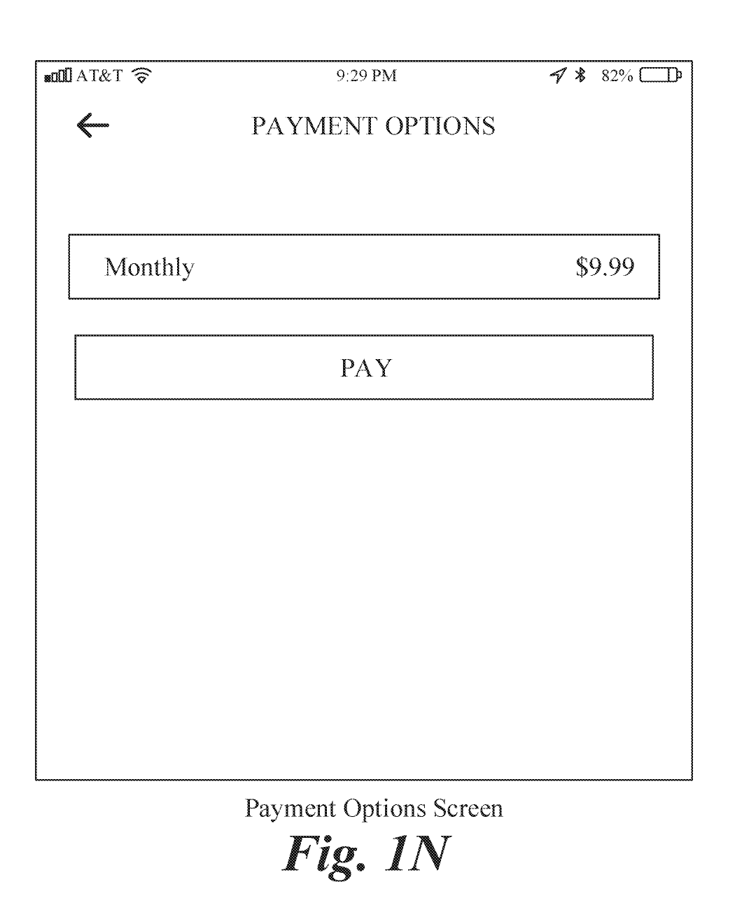

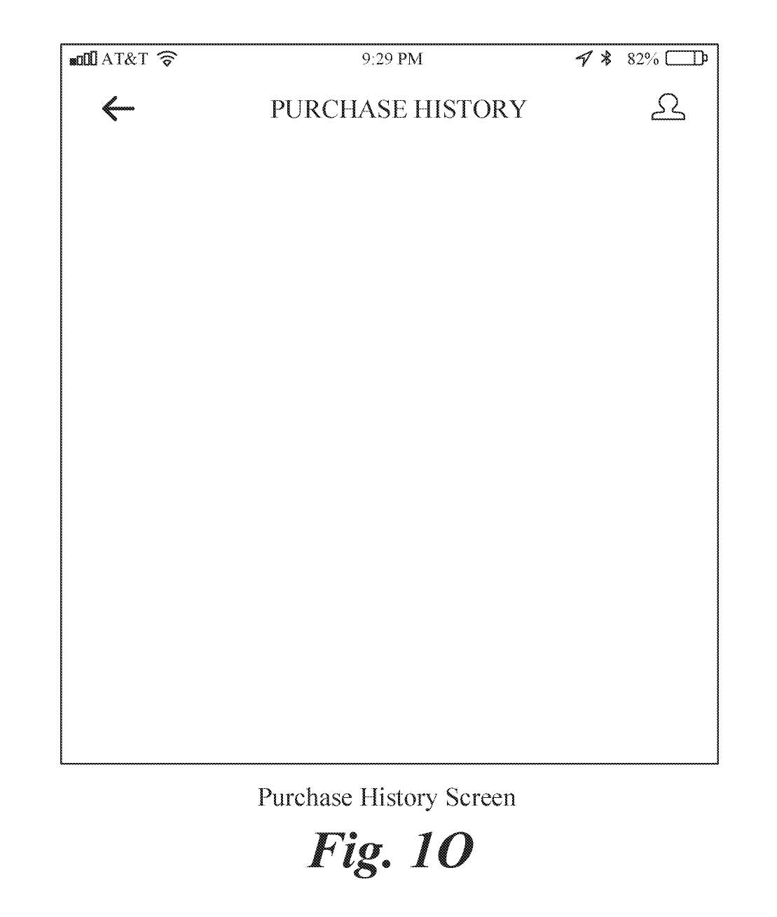

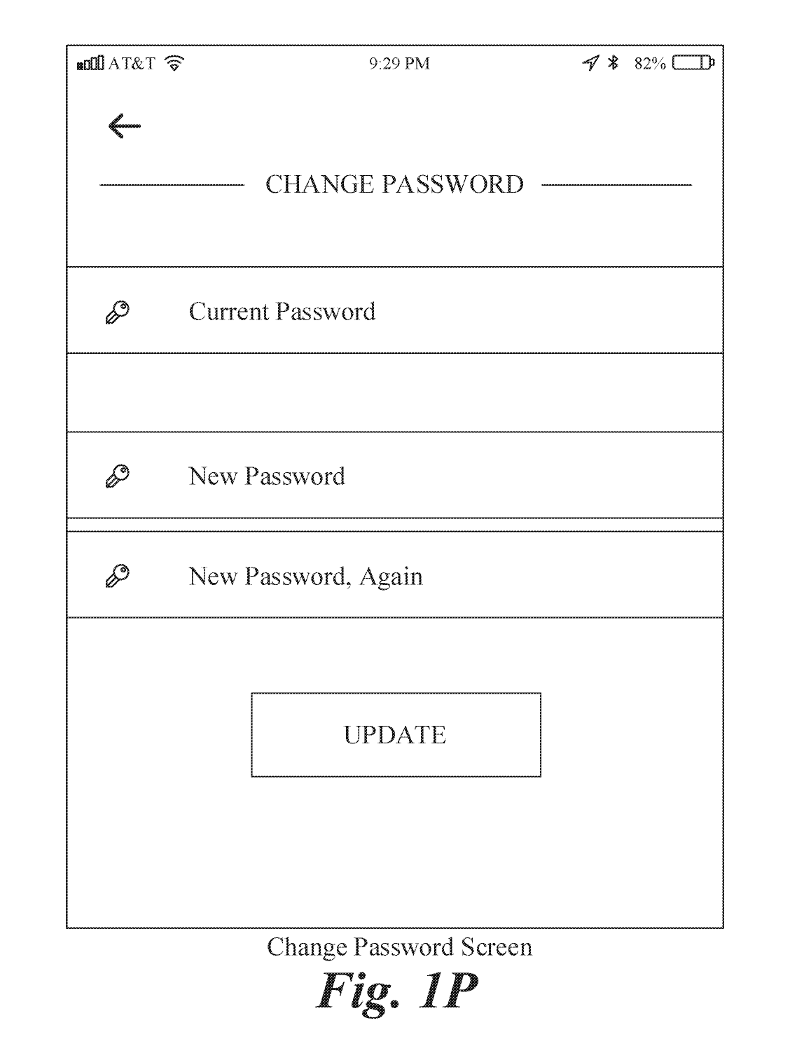

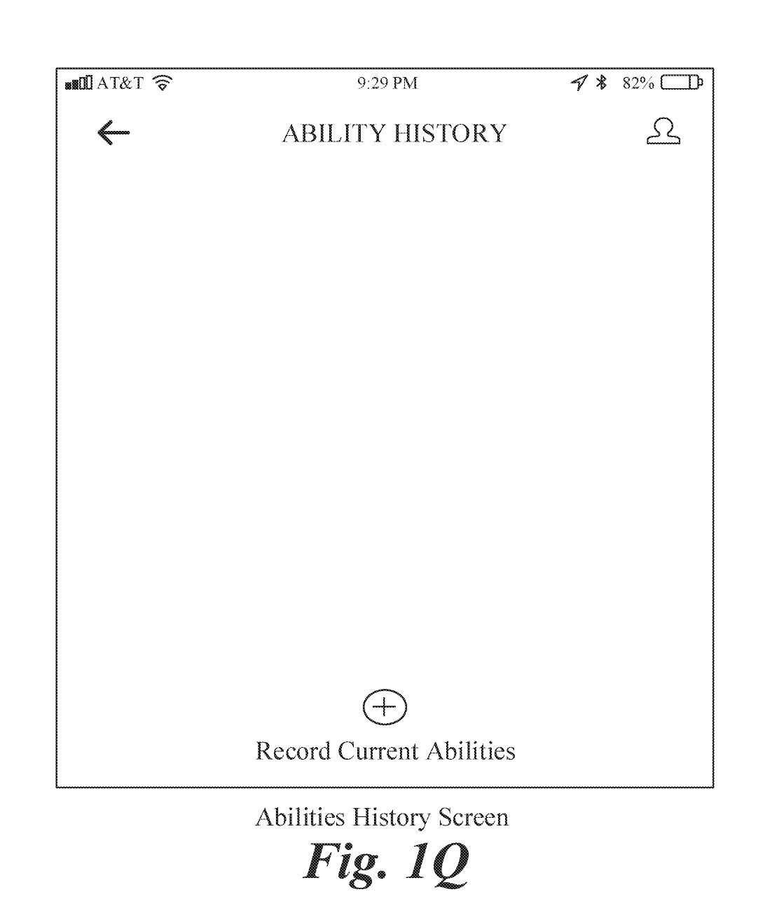

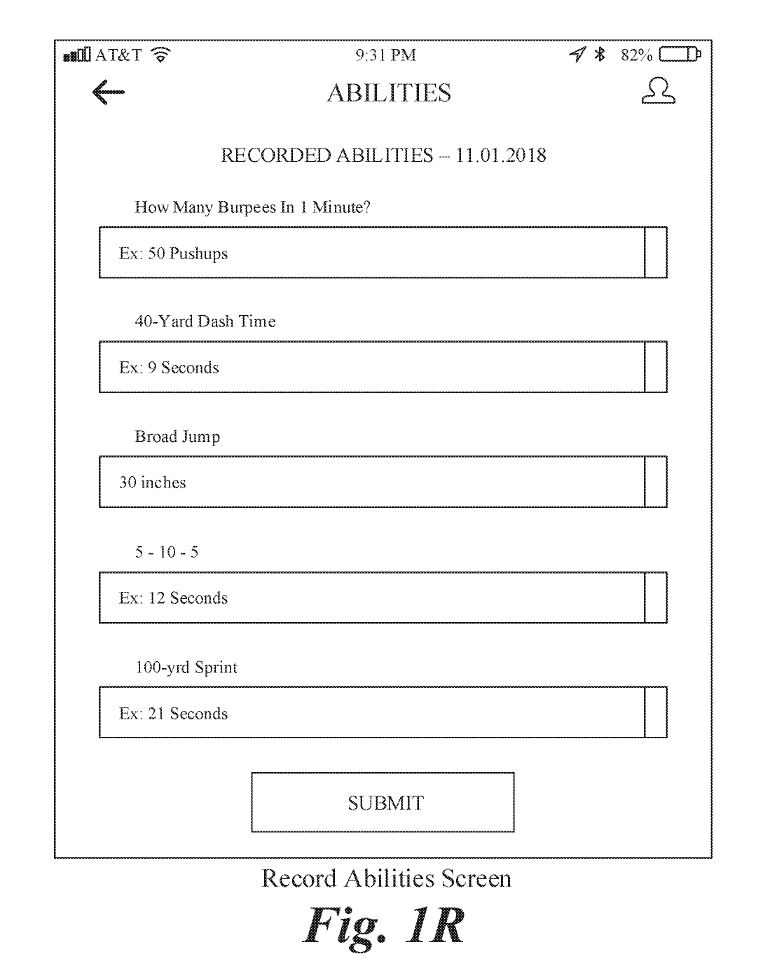

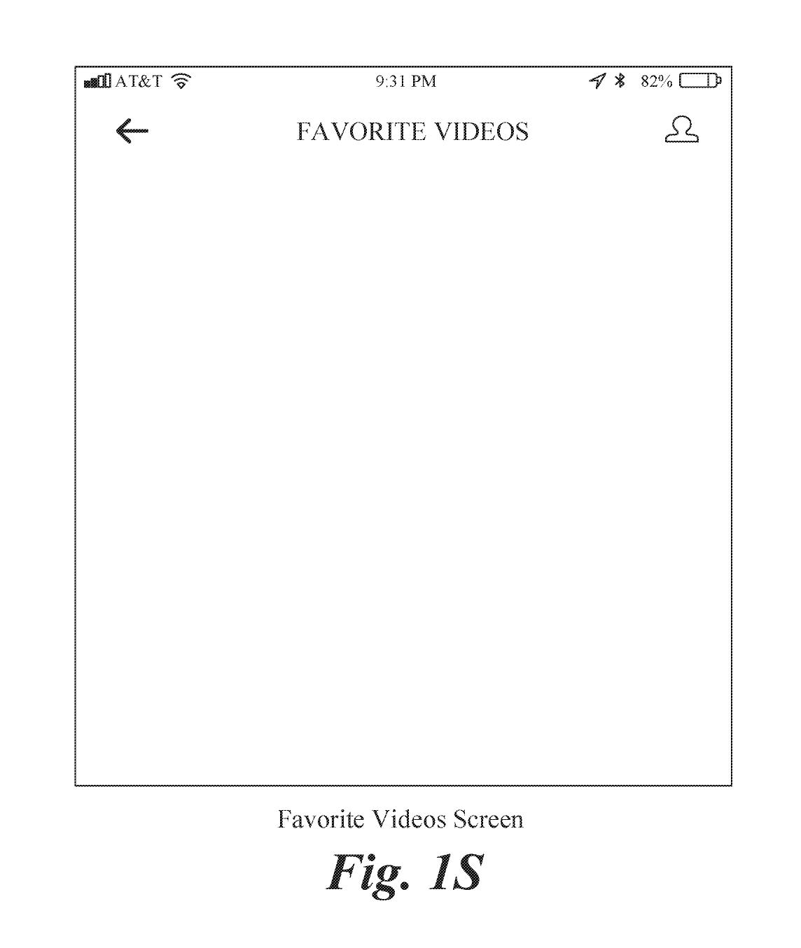

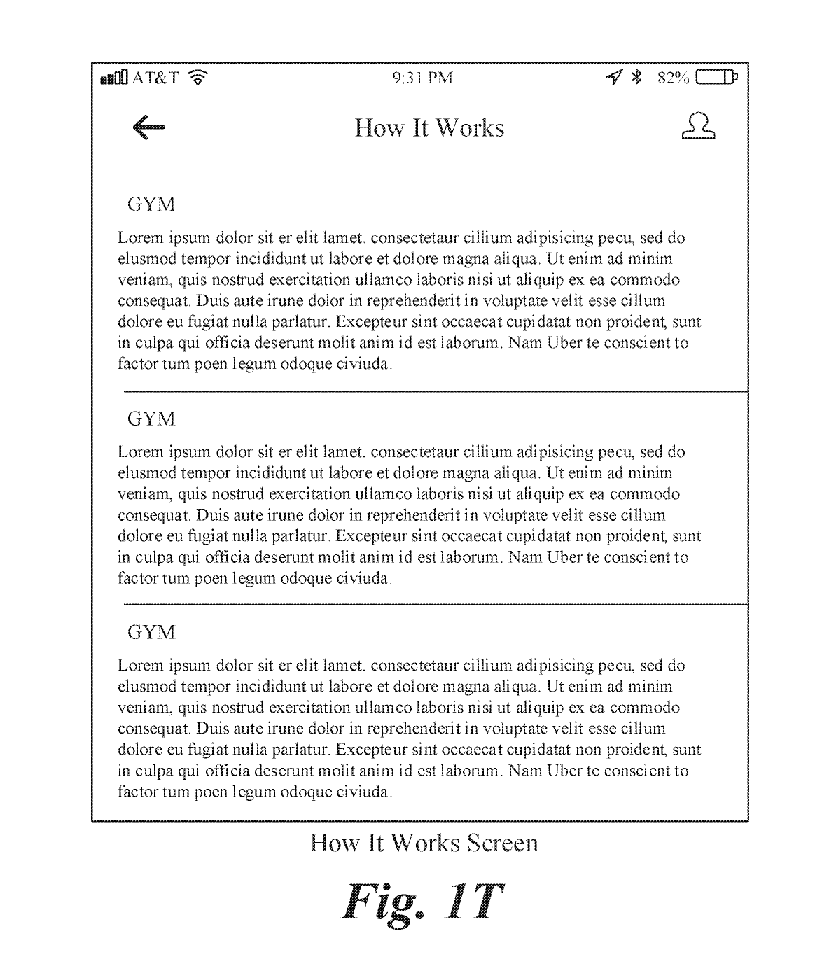

FIGS. 1A through 1T illustrate one embodiment of the invention through a series of wire frames for a subscription-based, mobile application. FIG. 1A depicts a welcome screen. By tapping “Let's Go!” on the welcome screen, the user can be lead to a hype video, as illustrated in FIG. 1B. The hype video, for example, can feature select athletes and run approximately two minutes, and is intended to create an interest and excitement for the user. When the hype video ends, users can automatically be taken to a registration screen, as illustrated in FIG. 1C. On the registration screen, the user is prompted to enter their pertinent information such as: first and last name and email. The user will then have the opportunity to create a unique username and password with which to identify themselves on the application platform. Users can also have the option of using their social media accounts to sign in (e.g., Facebook or Twitter). After completing the registration screen, the user can tap “Register” and be taken to the home screen, illustrated in FIG. 1D. In this embodiment, the home screen acts as the central hub that will allow users to navigate around the application platform.

FIG. 1D depicts three tiles, labeled “My Workout,” “Fevir TV,” and “Active Programs.” In this embodiment, tapping “View” on the My Workout tile will take users to the My Workout Screen (FIG. 1E), tapping “View” on the Fevir TV tile will take users to the Fevir TV Screen (FIG. 1F), and tapping “View” on the Active Programs tile will take the user to a breakdown of their completed and in-progress Fevir fitness programs (FIG. 1G). In FIG. 1D, the home screen also has a silhouette person icon on the top right of the screen that will take the user to the options screen (FIG. 1L).

Embodiments of the present invention satisfy the current “a la cart” culture where people have twenty or more different subscriptions in order to consume different facets of entertainment (e.g., Netflix, Amazon, Dailyburm, Spotify, and others). At the same time, embodiments of the present invention also provides a single platform that is economically stable and pre-combines, for a user, all the likely elements that a user is likely to select within one or more niche areas to fulfill the desires/needs of the user.

For example, the niche of sports: sports training, sport entertainment, sports content, sports role models, etc. By combining, for example, sports performance training and sport specific entertainment into one simple platform, the user pays one cost instead of four (working out, watching sports shows (live or otherwise), interacting with friends/athletes, and watching a classic sports film). Furthermore, thoughtful content placement will be appreciated by users. For instance, during the breaks between the workout programs and/or breaks within the workout in the program (30 sec, 60 sec, 2 min etc.), users will be presented with, for example, one-on-one interviews with the athletes whom they are working out alongside. Through these videos during the breaks, the user will learn details about the who, what, where, when, and why of the athlete. This provides a peek behind the curtain and makes the experience more entertaining as well as more personal.

In a preferred embodiment and as demonstrated by FIG. 1D, the application platform can be analogized as Beachbody meets ESPN meets Netflix, and is able to provide an improved solution to serve market needs, needs which the general public may or may not even be aware of yet. Once these particular combinations are offered to them, however, this seemingly incremental improvement can result in the present invention becoming a necessary mode of consuming content and thus, in turn, create a huge and new marketing platform for displaying content.

FIG. 1E depicts the My Workout screen. The My Workout screen features links for the user to follow to the specific instructional workout for that day as well as optional warm-up and stretching videos. The top video link will take the user into the workout for the day. After tapping the play button, the video will begin streaming immediately. The two to three videos below the other video link will link the users to the optional warm-up and pre-workout stretch and mobility videos. In FIG. 1E, the screen includes two icons that will inform the user what “attributes” they will be working on with the specific workout. The screen also includes an informational paragraph specific to the day's workout that will let the user know what to expect. Additionally, the screen includes a “Featuring” section and an “Equipment Needed” section that inform the user who the featured athlete is for the specific workout and the equipment that they will need to complete the day's workout.

FIG. 1F depicts the Fevir TV screen. In FIG. 1F, the Fevir TV screen has three main tiles. By tapping “View” on the Fevir Curtain Pull tile, users will be taken to the Fevir Curtain Pull Screen (FIG. 1G). Tapping “View” on the TV tile and Movie tile, respectively, will take users to pages that will allow them to stream their favorite sports entertainment licensed content (not depicted here as separate wireframe screens).

As such, in this embodiment of the present invention, the application platform will allow for the exclusive or nonexclusive distribution and/or streaming of sports-related entertainment through, for example, license or purchase agreements with third parties or eventually, original movies or televisions shows. As a non-exhaustive list of example, distribution and/or streaming of sports related entertainment could include, but is not limited to, sports movies (e.g., Field of Dreams, Any Given Sunday, Hoosiers, Major League, The Natural, Miracle, Friday Night Lights etc.), sports television shows (e.g., Coach, Hard Knocks, Friday Night Lights, Blue Mountain State, Celebrity Deathmatch, Guts, The Hoop Life, Rocket Power, The Contender), and/or sports-related games created originally or modified with permission, acquired from other developers, or licensed through third parties (e.g., Tecmo Bowl, Madden, Blades of Steel, Punch Out, NBA Jam, Fifa)—all of which can be consumed on, for example, a mobile device, computer, or any other device accessible to wireless or cellular networks. In some embodiments, content data will be hosted within servers and remotely accessed through the mobile application. In other embodiments, such data can be stored and accessed offline.

FIG. 1G depicts the Fevir Curtain Pull screen. In this embodiment, the Fevir Curtain Pull screen provides the user with multiple videos with content ranging from, for example, select athlete interviews to behind-the-scenes videos of select productions and select athlete lives. By tapping play on any of these videos, the user will instantly be able to stream the content to their preferred mobile device.

As such, in this embodiment of the present invention, the application platform will allow for the release of original entertainment content. Professional athletes, for example, can utilize the fact that there are many opportunities in mobile content (e.g., Twitter, Facebook, Instagram, Snapchat) because a majority of the population can easily access such mobile content in this age of mobile devices. Mobile content is generally easy to create utilizing the video and camera features on the mobile device, and content typically consumed and generated via a mobile device are not of high production quality. In contrast, embodiments of the present invention can leverage both low production value and high production value content.

As a non-exhaustive list of example, original content can include, but is not limited to, up close and personal behind-the-scenes access to these athletes. Original programs and content can include, but are not limited to, inspirational interviews, docuseries, scripted series, original movies, live-streams (e.g., everything from streaming live sporting events to Q&As where consumers get to interact directly with athletes), instructional videos, games and other content that is new, unique and exclusive to embodiments of the invention.

Therefore, embodiments of the present invention create new avenues of marketing, branching, and outreach. Through embodiments of the present invention, new classes of cultural influencers can be created to empower users receiving the content through motivation and education. Those users who create the content, e.g., athletes, can utilize the present invention's unique media platform to use their voice to drive change around the world through, e.g., sports. As previously discussed, such original content can feature a variety of athletes, celebrities, and other people from multiple disciplines and embodiments of the present invention become a means for users to access and watch such content.

FIG. 1H depicts the Active Programs screen. In this embodiment, the Active Programs screen shows the user all workouts which are currently active on their profile (for example, depicted here is the “Beta Program”) as well as all available and upcoming training programs such as, football, baseball, etc. (not specifically depicted here). Tapping on a specific program (e.g., the Beta Program) will take the user to the Program Overview Screen (FIG. 1I) that will show the user the 6-, 8-, or 12-week breakdown for the specific program. By tapping “Week 1,” the user will be taken to the Weekly Overview screen (FIG. 1J) that will show the user the daily breakdown for that specific week of the program. By tapping on a specific day (e.g., Day 1), the user will be taken to the My Workout screen (illustrated in FIGS. 1E and 1K) where they will be able to begin the specific workout for that day (e.g., Foundational Strength as illustrated in FIG. 1J).

FIG. 1L illustrates the options screen. In this embodiment, the options screen can be accessed any time by tapping the silhouette person icon on the top corner (illustrated in multiple screens: FIGS. 1D, 1E, 1F, 1G, 1H, 1I, 1J, 1K, 1M, 1O, 1Q, 1R, 1S, and 1T). The options screen gives the user a menu in which to update pertinent information on their application platform profile and view user-specific data. For example:

By Tapping “Profile,” the user is taken to the Personal Information screen (FIG. 1M). In FIG. 1M, the Personal information screen allows the user to add a profile picture, update their first and last name, update their email address, update their sex, add a profile picture, etc.;

By tapping “Payment Info,” the user is taken to the Payment Options screen (FIG. 1N). In FIG. 1N, the Payment Options screen allows the user to select the specific monthly subscription that fits within their budget. By tapping “Purchase History,” the user will be taken to the Purchase History screen (FIG. 1O). On the Purchase History Screen illustrated in FIG. 1O, users will be able to see all purchases that they have made in the application platform (e.g., subscriptions and any additional content);

By tapping “Change Password” the user is taken to the Change Password screen (FIG. 1P). On the Change Password screen illustrated in FIG. 1P, the user will be able to change the password that they use to access the application platform;

By tapping “Personal Abilities,” the user will be taken to the Ability History screen (FIG. 1Q). On the Ability History screen illustrated on FIG. 1Q, the user will be able to access a library of previously recorded abilities on the platform by which they can measure their progress. At the bottom of the screen, the user can tap “Record Current Abilities” and will be taken to the Record Abilities screen (FIG. 1R). On the Record Abilities screen illustrated in FIG. 1R, the user will be able to record their current fitness abilities for different physical activities (e.g., 40 yard dash time, broad jump distance, and others). These performance metrics can also be carefully curated by qualified instructors and trainers, and users can use this information to continue measuring their performance and improvements in a standardized way, much like information gathered in an NFL scouting combine (e.g., if the user is participating in a football program, then the user will have a mock combine test to check progress from start to finish). Therefore, users can test their abilities using the same format the professional athletes use;

By tapping “Favorite Videos,” the user will be taken to the Favorite Videos screen (FIG. 1S). On the Favorite Videos screen illustrated in FIG. 1S, the user will be able to access a list of videos that they have favorited across the platform (not specifically depicted here);

By Tapping “How It Works,” the user will be taken to the How It Works screen (FIG. 1T). In FIG. 1T, the How It Works screen will provide the user with pertinent information about, for example, the application platform, the workouts, and the company and/or curators as a whole (specific details not shown); and

By tapping the home icon on the top right corner in FIG. 1L, the user will be taken back to the home screen (FIG. 1D).

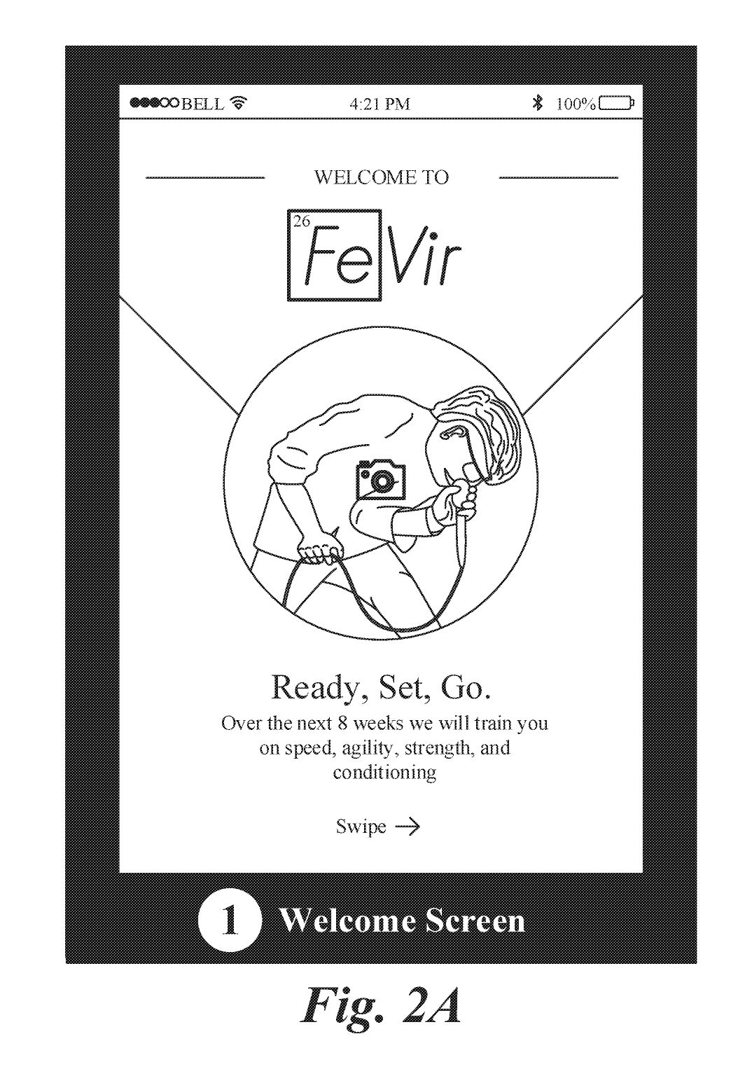

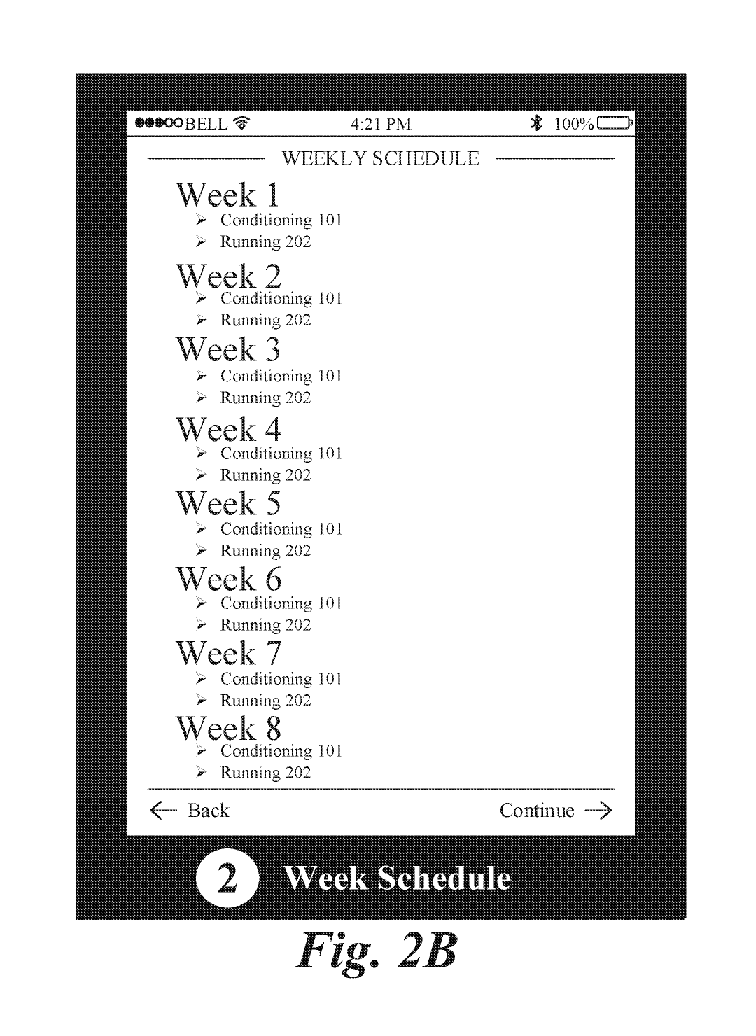

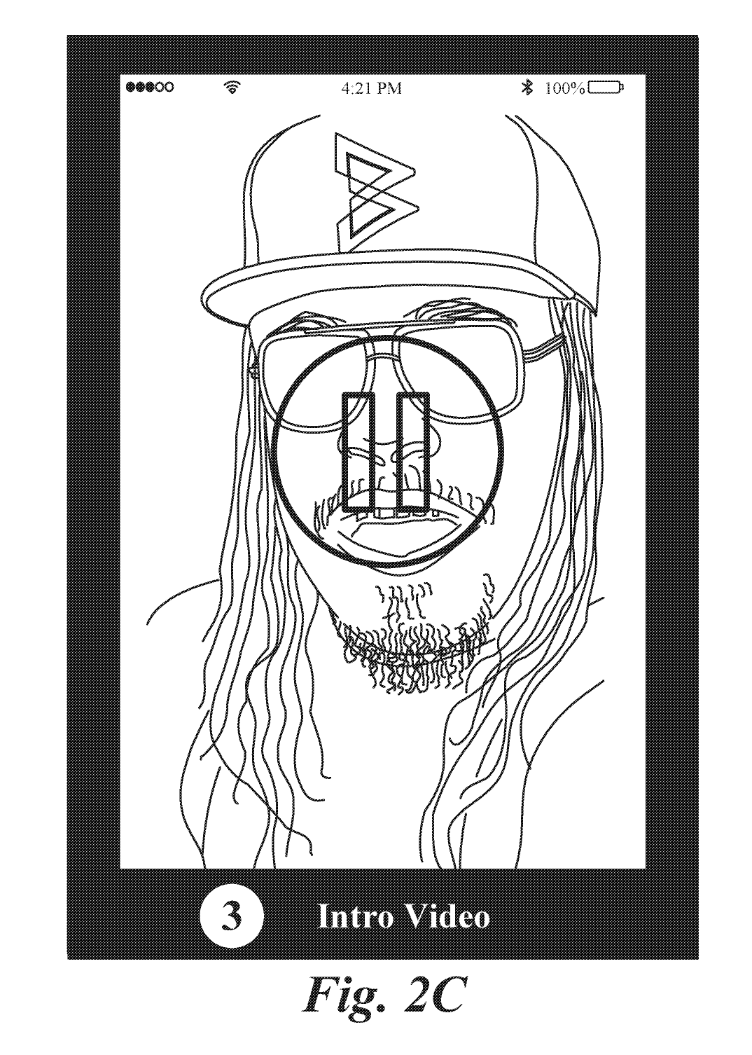

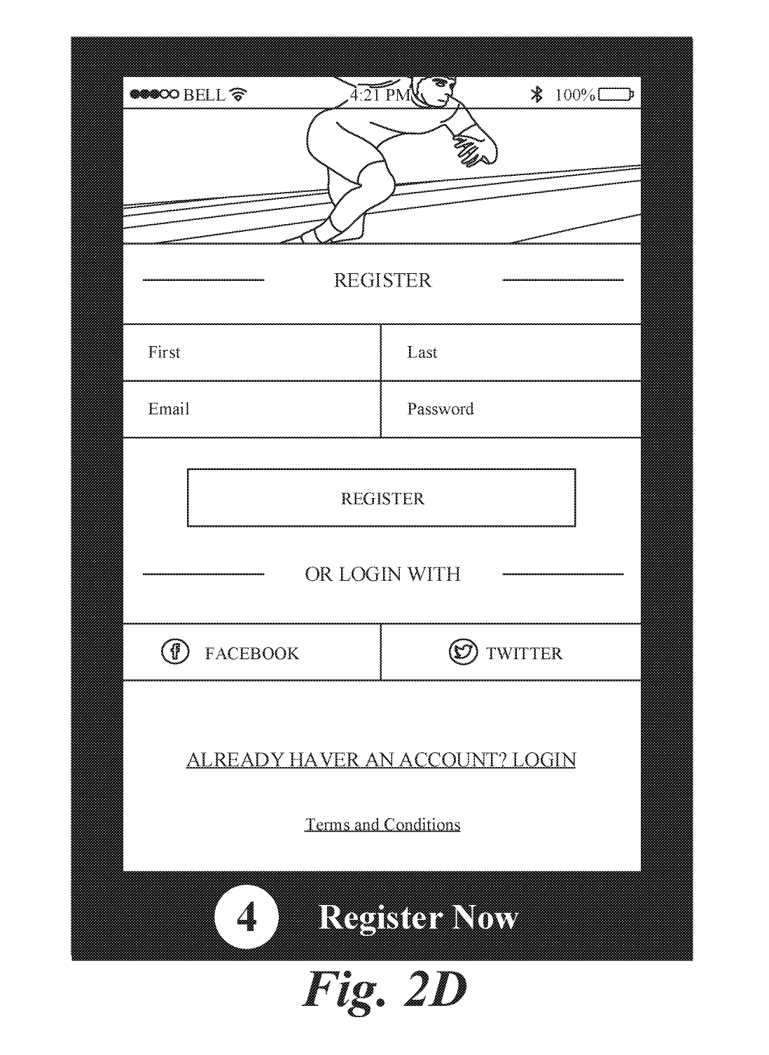

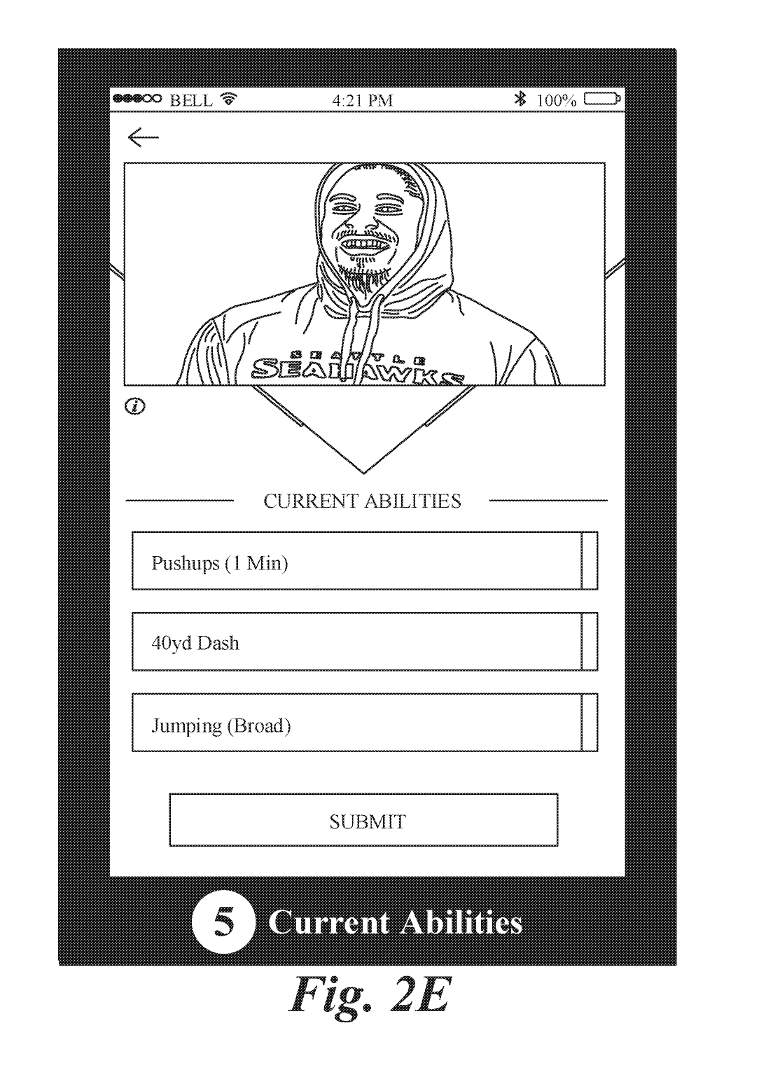

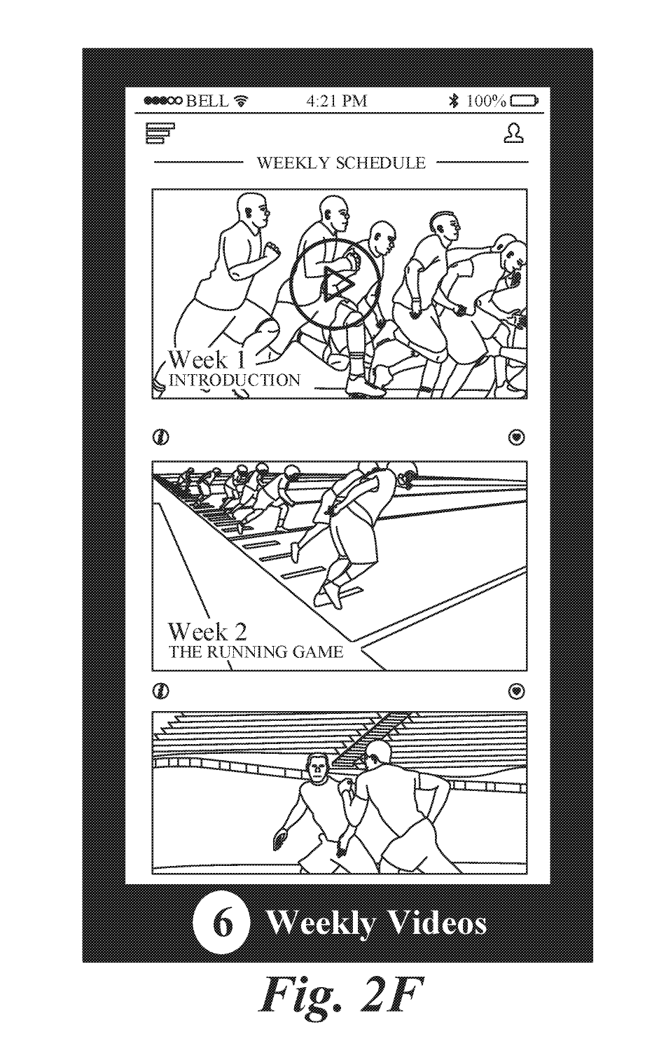

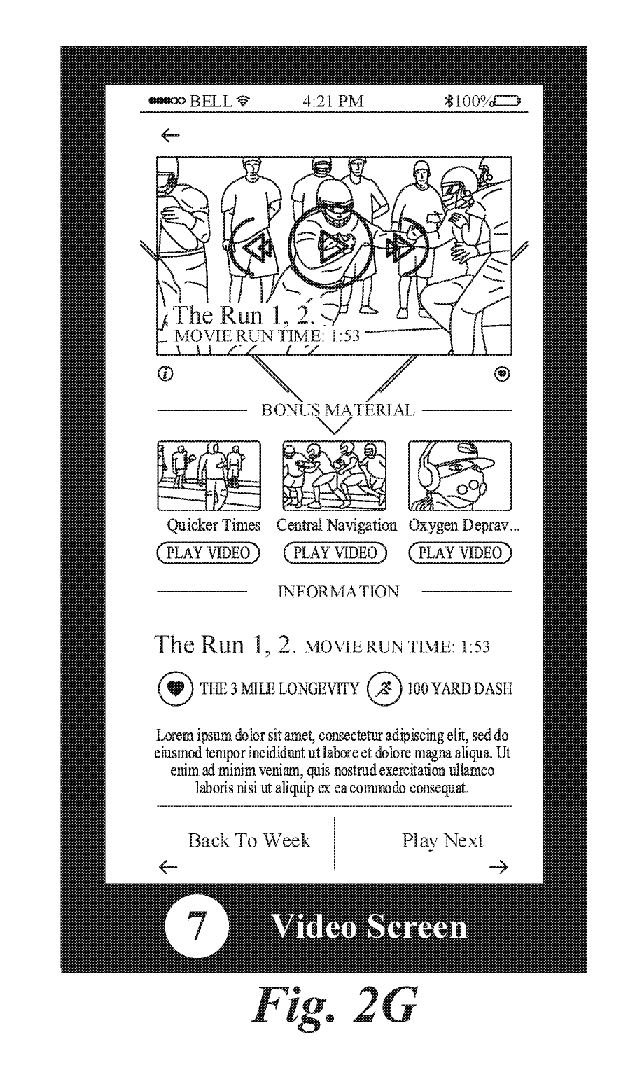

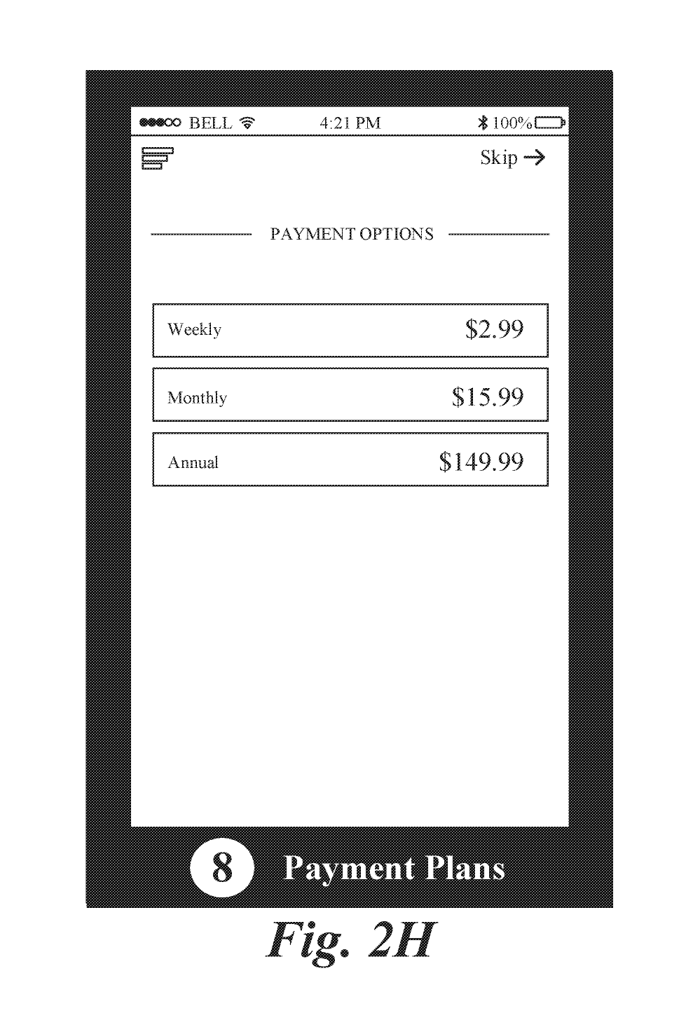

FIGS. 2A through 2H illustrate another embodiment of the invention through a series of different wire frames for a subscription-based, mobile application, in which a user interacts with the embodiment via a mobile phone through the steps of: (1) viewing the welcome screen as illustrated in FIG. 2A; (2) accessing a weekly schedule as illustrated in FIG. 2B; (3) playing an introductory video as illustrated in FIG. 2C; (4) registering on the mobile phone application as illustrated in FIG. 2D; (5) assessing his or her current abilities as illustrated in FIG. 2E; (6) accessing weekly videos as illustrated in FIG. 2F; (7) viewing particular video content as illustrated in FIG. 2G; (8) selecting a payment plan as illustrated in FIG. 2H.

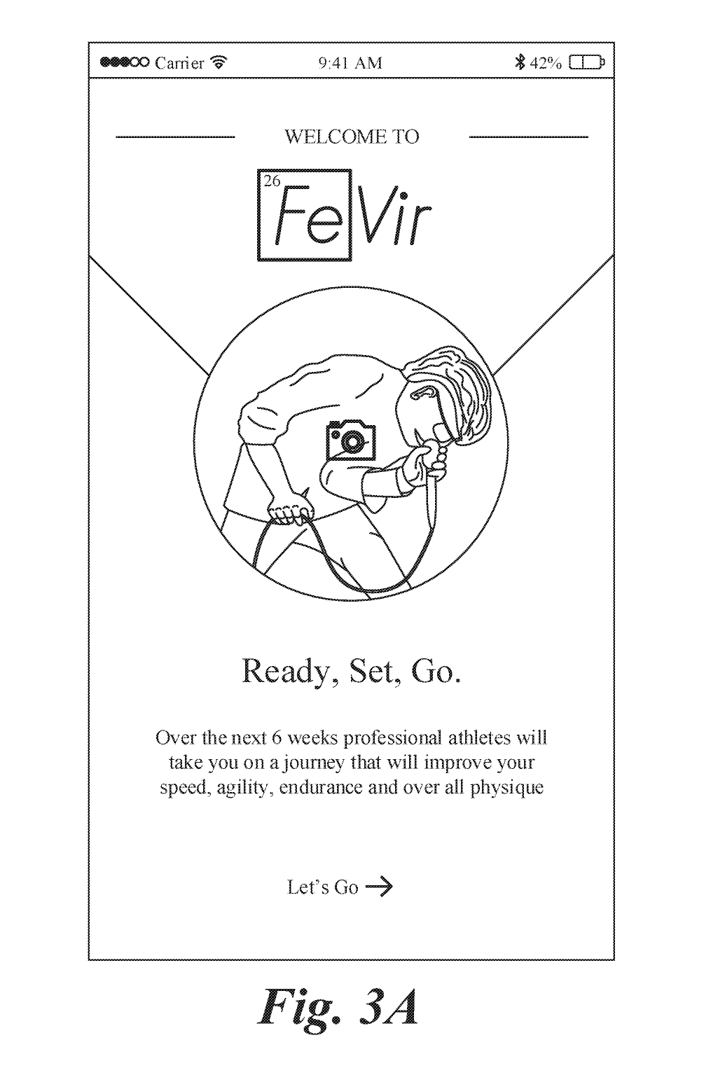

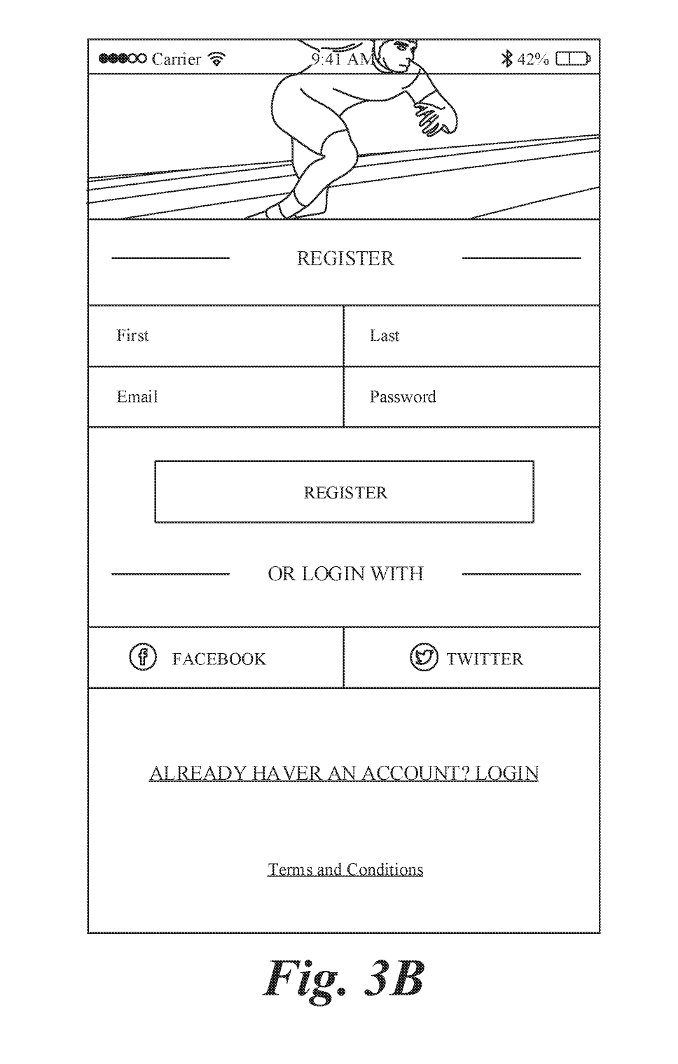

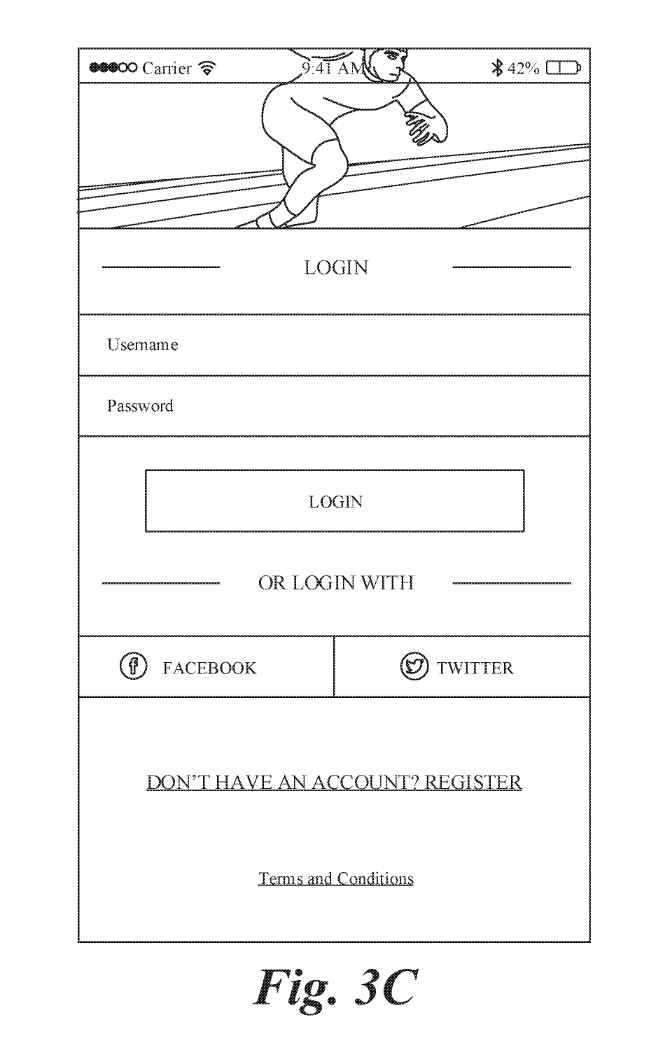

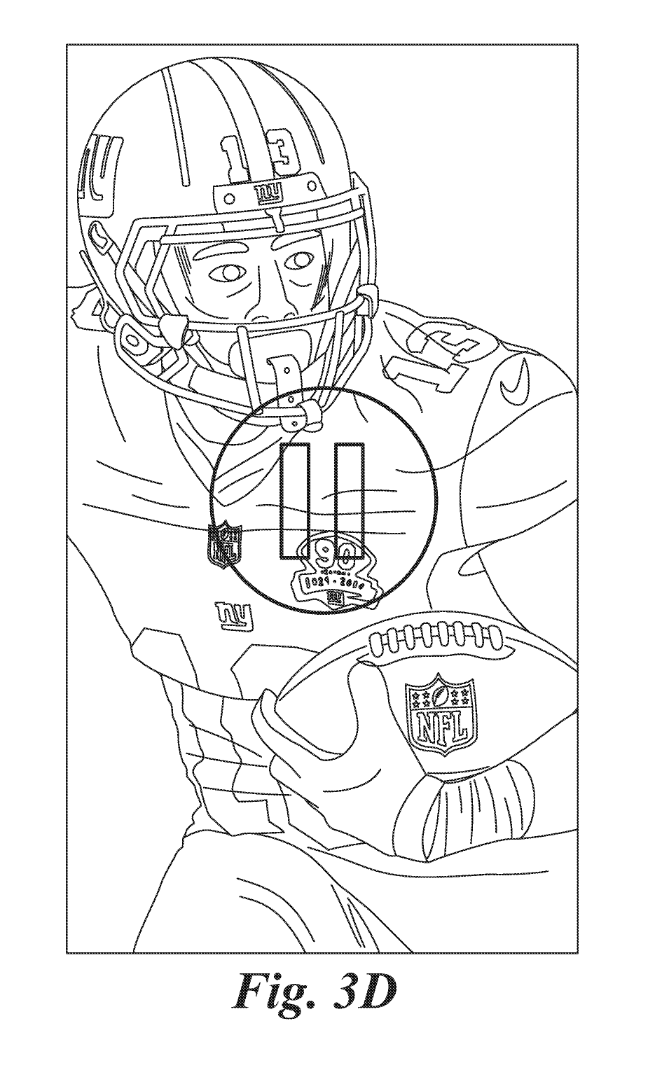

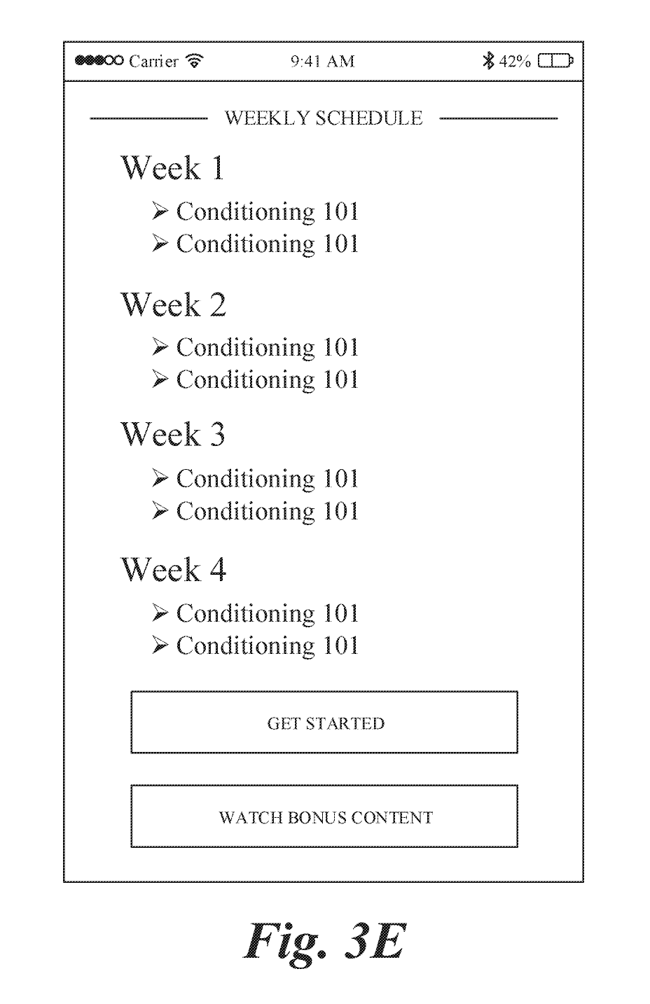

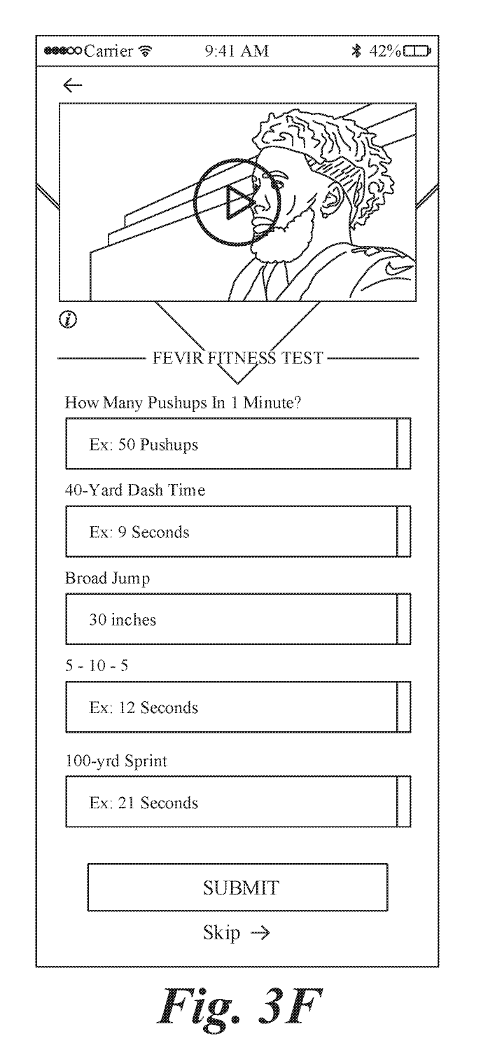

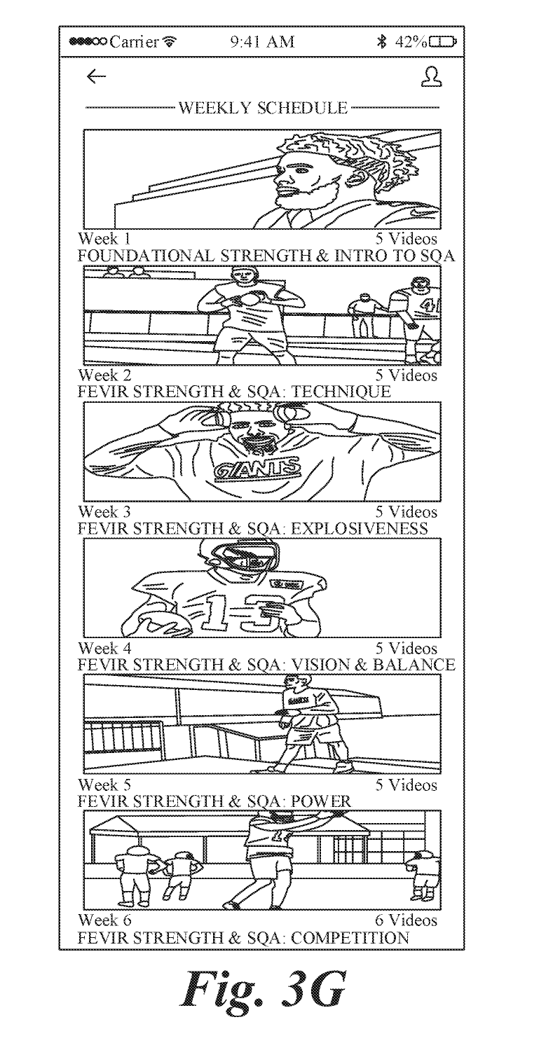

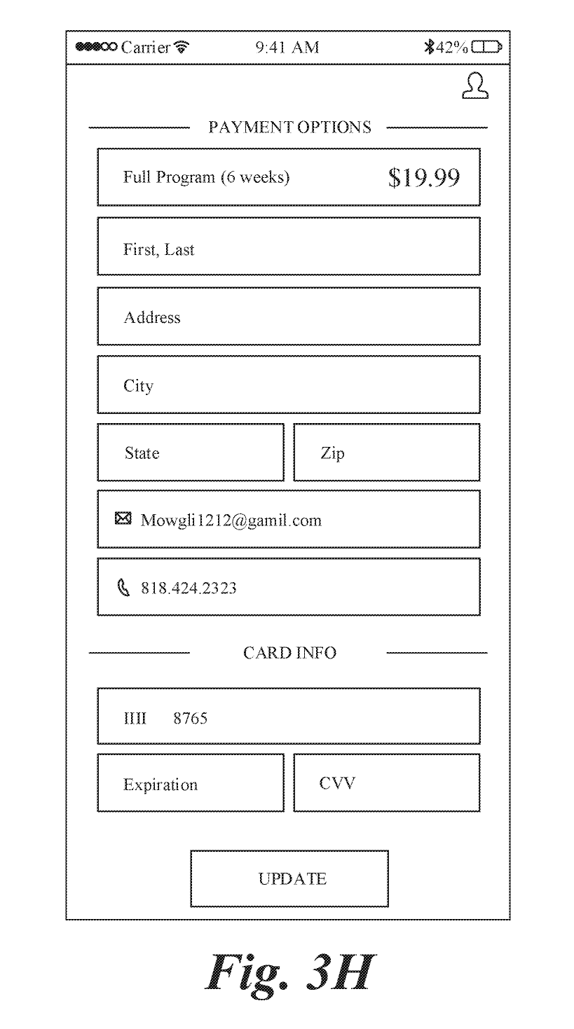

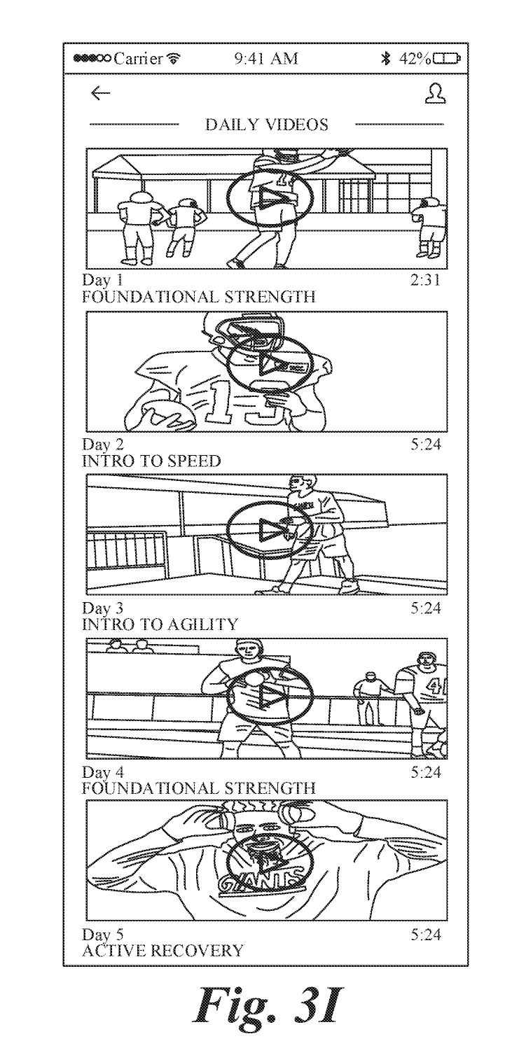

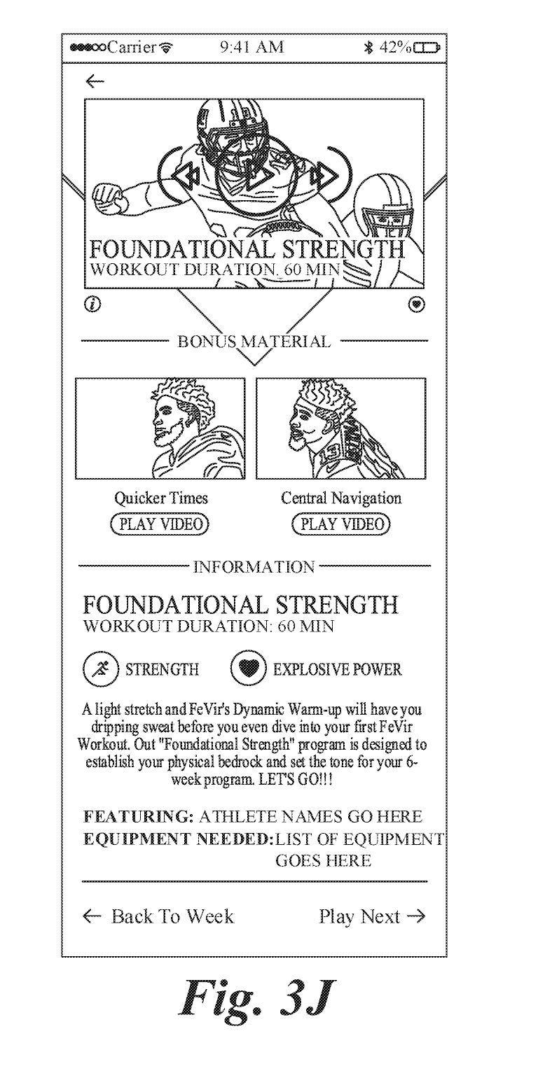

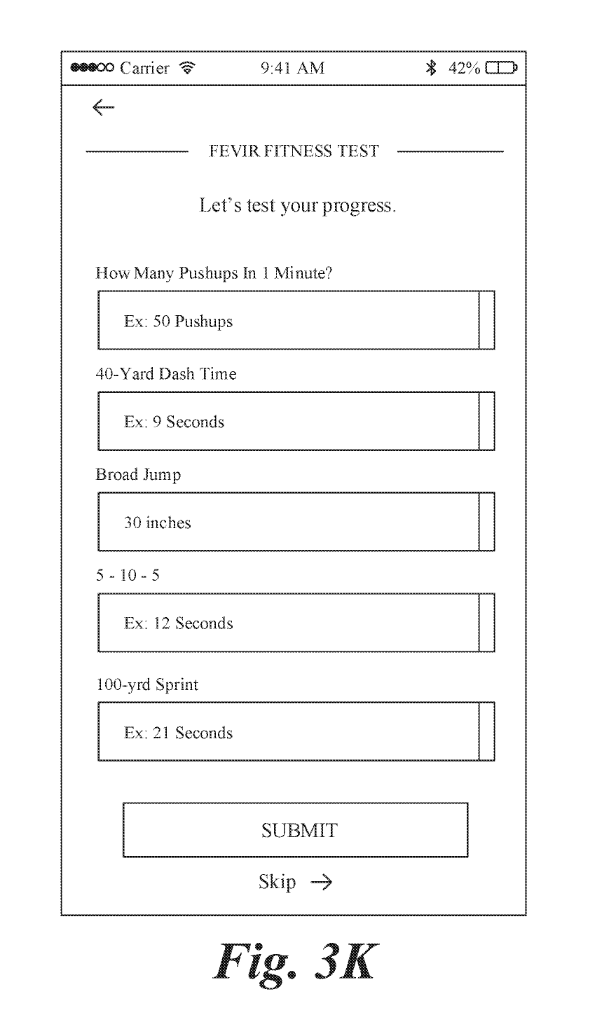

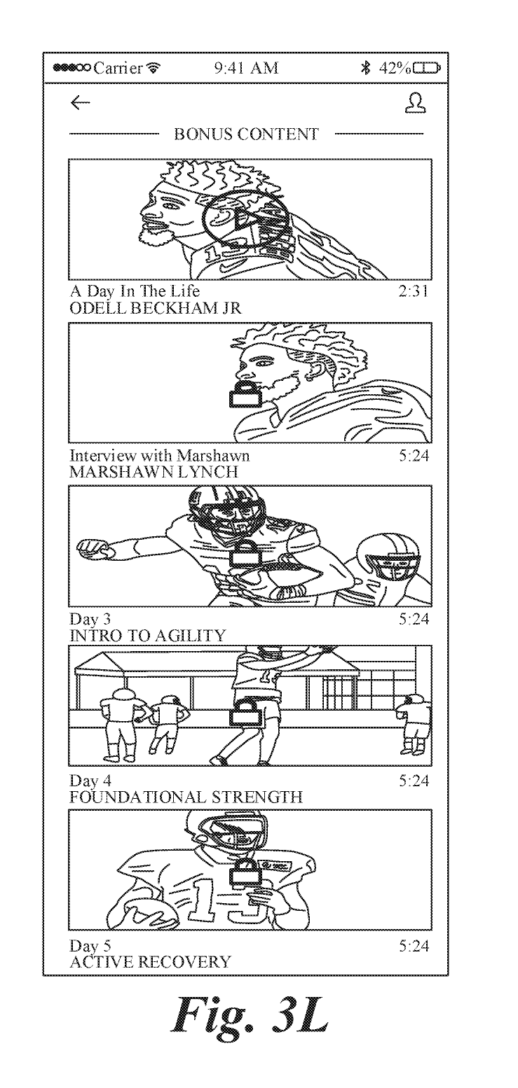

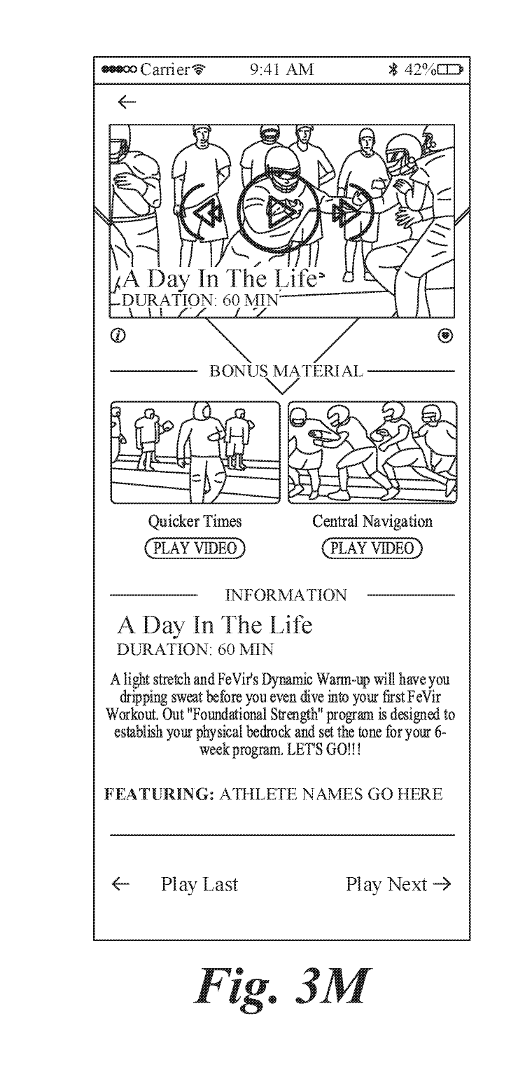

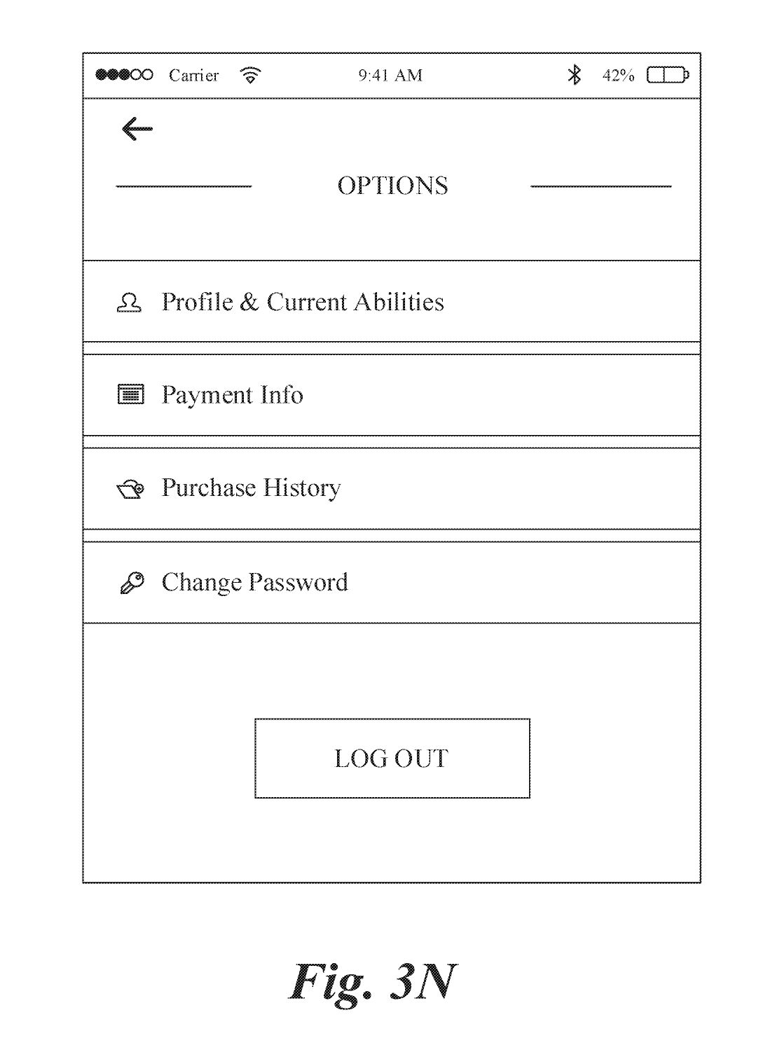

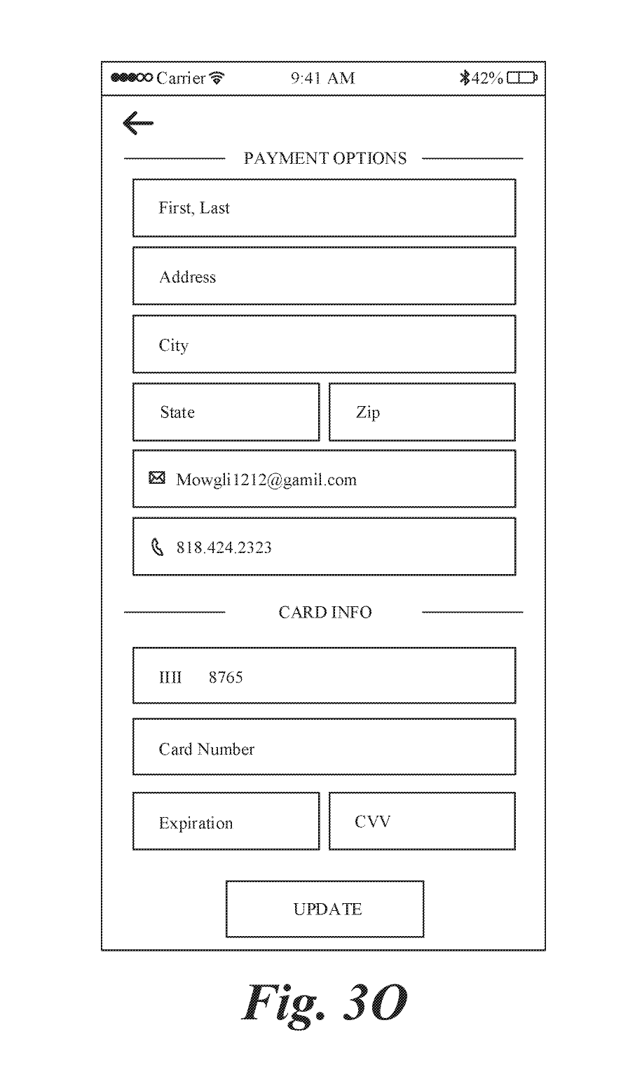

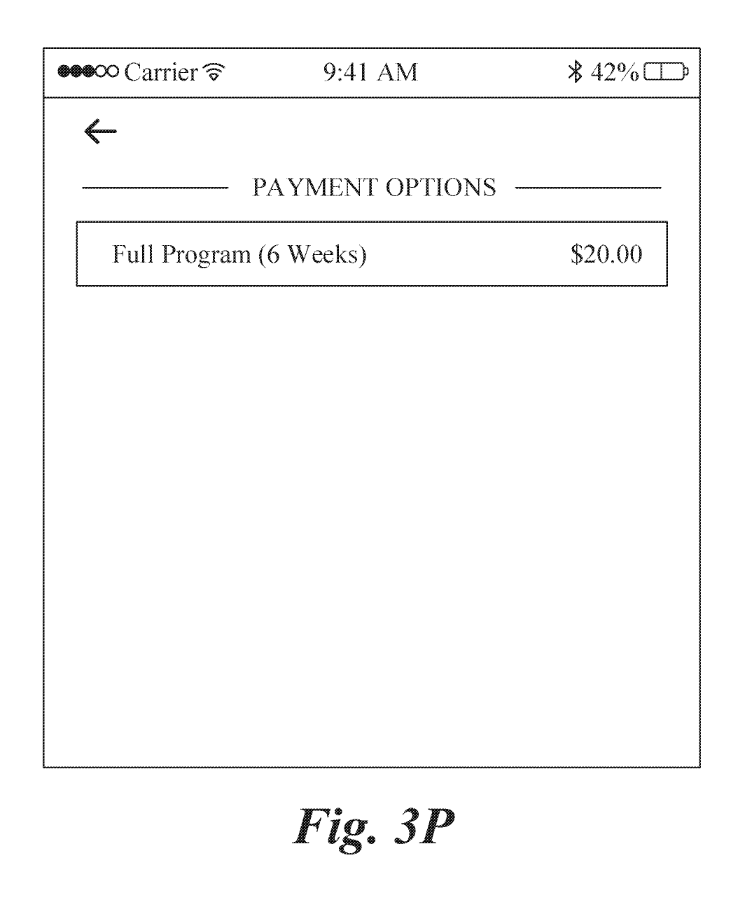

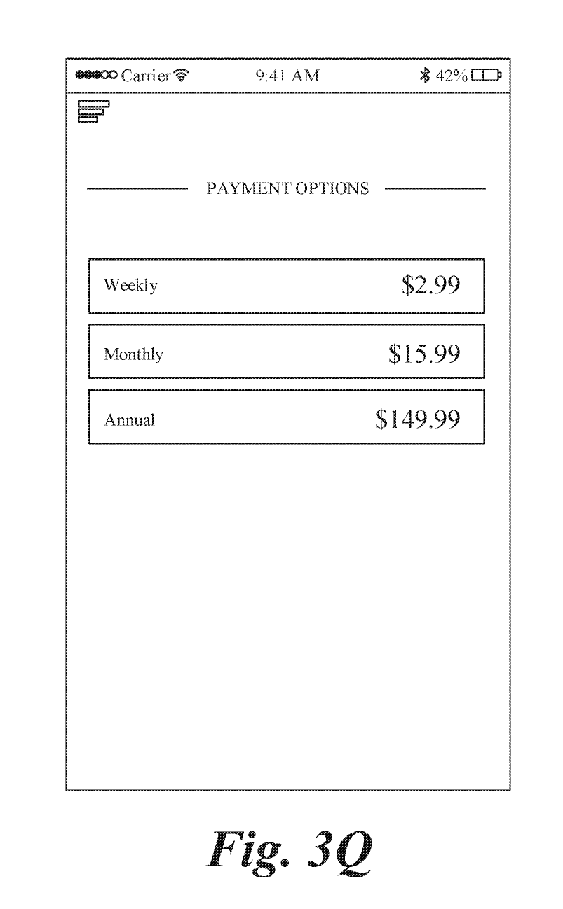

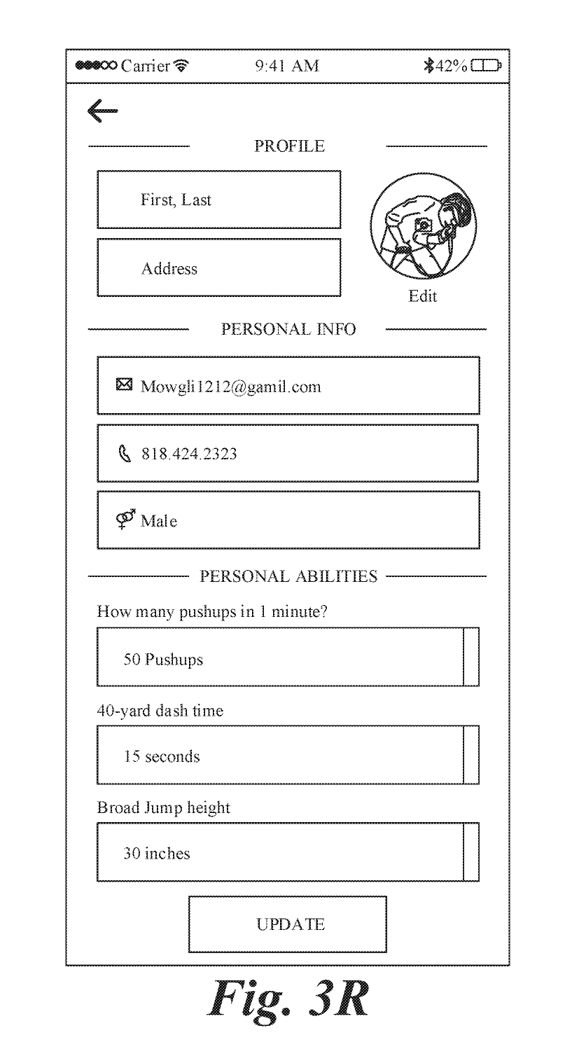

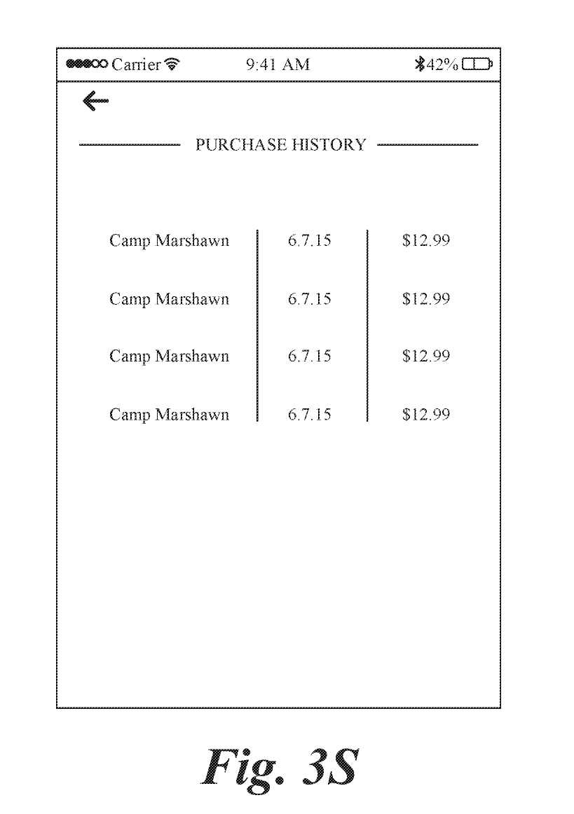

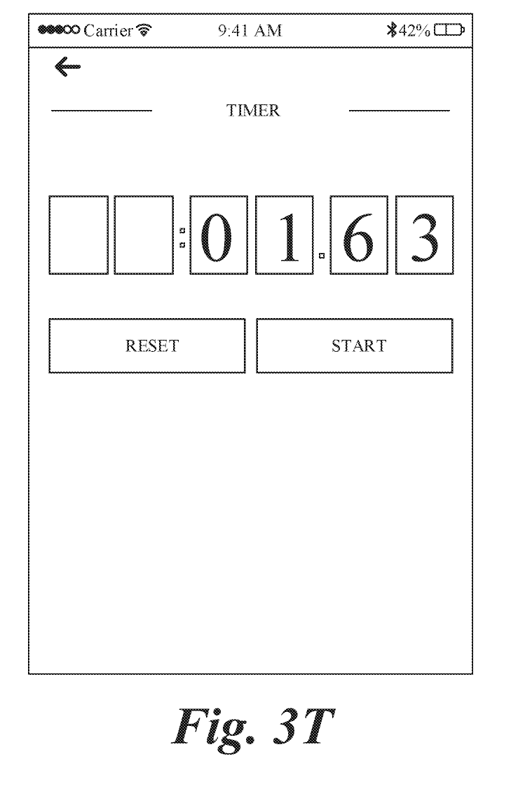

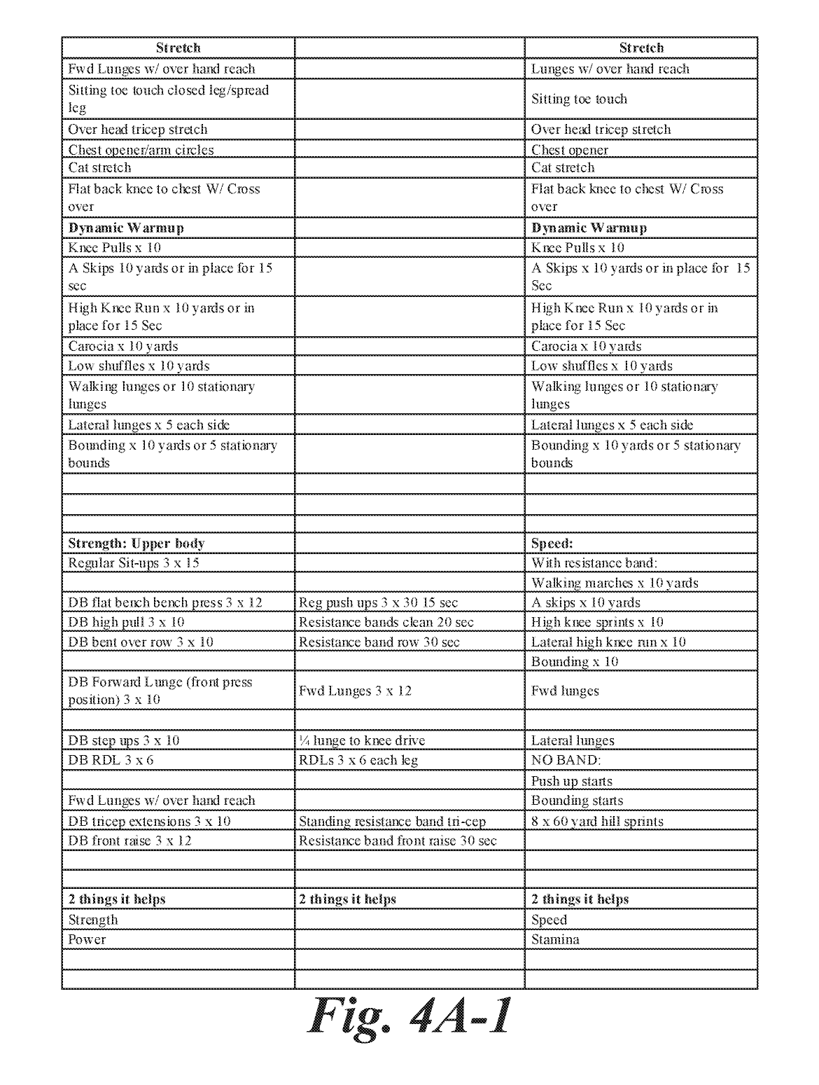

FIG. 3A illustrates another embodiment of the welcome screen.

FIG. 3B illustrates a registration screen, while FIG. 3C illustrates a log-in screen.

FIG. 3D illustrates another example of a hype video, intro video, and/or other video.

FIG. 3E illustrates another embodiment of the weekly schedule. In FIG. 3E, the weekly schedule is for conditioning, and the user may start the program by tapping “Get Started” or consume other content by tapping “Watch Bonus Content.”

FIG. 3F illustrates one embodiment in which the user can conduct a guided fitness test. This information on this page can then be recorded in the application platform so that the user may continue track their fitness and performance. See also FIG. 1R.

In other embodiments, the data input and data fields can correspond with data gathered automatically from, for example, the GPS mapping, bio-signal monitoring, gaming, and wearable biometric clothing.

FIG. 3G is another embodiment of the weekly schedule. In FIG. 3G, the weekly schedule provides the user with an overview of the order in which different programs and routines will take place, and indicate that each program has 5 videos for each week.

FIG. 3H is another embodiment of the payment information and options screen.

FIG. 3I illustrates one embodiment of an overview of daily videos.

FIG. 3J illustrates another embodiment of the day's workout, with the featured video for that day, and then additional bonus content with topics such as “Quicker Times” and “Central Navigation.”

FIG. 3K illustrates another embodiment for fitness and/or performance tracking, but without a video featured as illustrated in FIG. 3F.

FIG. 3L illustrates one embodiment of a library of bonus content.

FIG. 3M illustrates one example of bonus content, with additional bonus material and information related to such bonus content.

FIG. 3N is another embodiment of the options screen.

FIG. 3O is another embodiment of the payment screen.

FIG. 3P is one embodiment of the payment options (by program), and FIG. 3Q is another embodiment of the payment options (by subscription period).

FIG. 3R is one example of a screen that collectively displays profile information unique to the user (profile, personal information, and personal abilities).

FIG. 3S is another embodiment of a purchase history screen.

FIG. 3T is one optionally advantageous feature of the present invention, in which there is a timer within the application platform for the user to utilize.

As discussed, a preferred embodiment of the present invention provides a user a means to achieve his or her fitness and/or athletic goals by following fitness programs that are created by some of the best sports performance trainers in the world.

For example, the programs exercises can vary (e.g., functional movement and/or performance training), but each day and each week is carefully laid out. For example, programs can follow a format of videos 4-5 days a week (to allow flexibility/breathing room to users as well as rest for the body), over a total 6 week period: two strength days, a speed day, an agility day, and an active recovery day.

Similarly, the visuals are also thoughtfully planned. Most conventional instructional exercise classes/videos/demonstration are line cut and strictly workout. Embodiments of the present invention are unique in production value and entertainment value. In a preferred embodiment, visually, the user can see the workouts being demonstrated utilizing split screens and full screens as to not waste space, particularly on mobile devices with smaller screens. This allows users to get the most out of their instruction. As previously discussed, additional content (e.g., one-on-one interviews) can also be strategically placed so as to make the workout a more seamlessly informative, fun, and personal experience.

In other embodiments, the present invention can be integrated with other mobile applications, such as music applications like Spotify, Pandora, and eventually, for example, a native application platform music platform that allows users to access the athletes' workout playlists that can be played during the user's workouts, serving as a soundtrack, or just for fun outside of these workout programs.

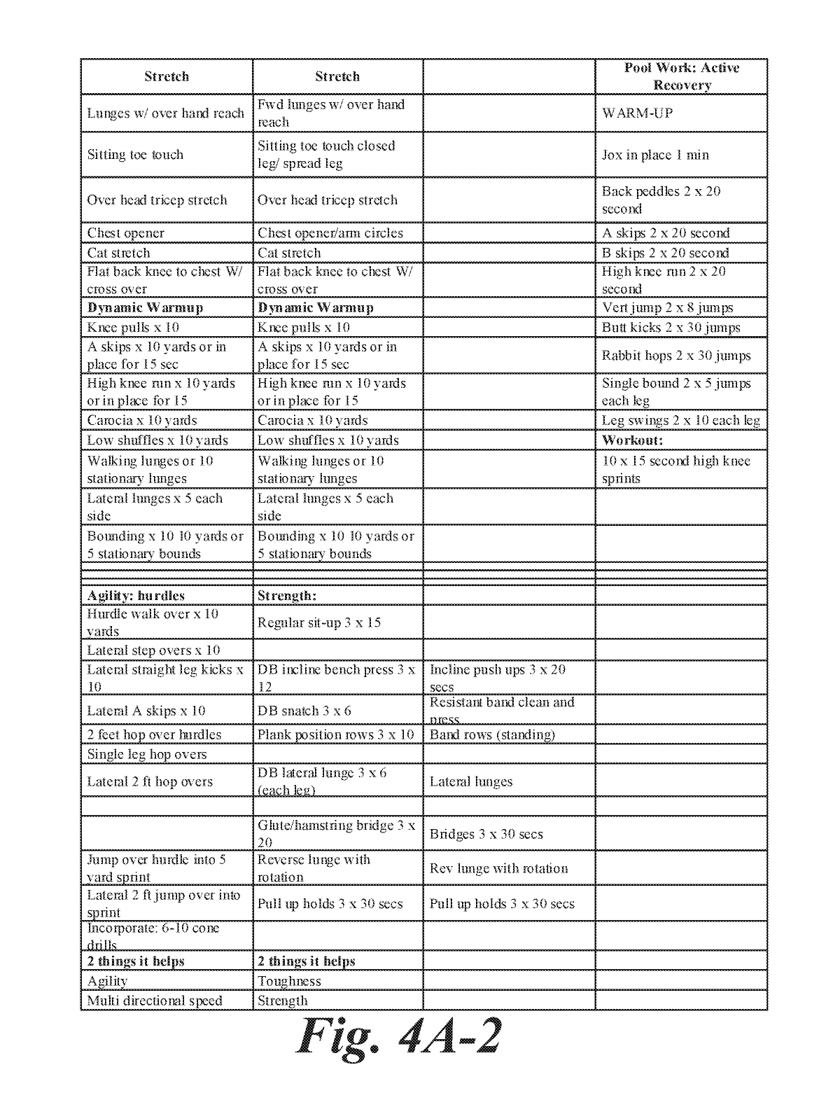

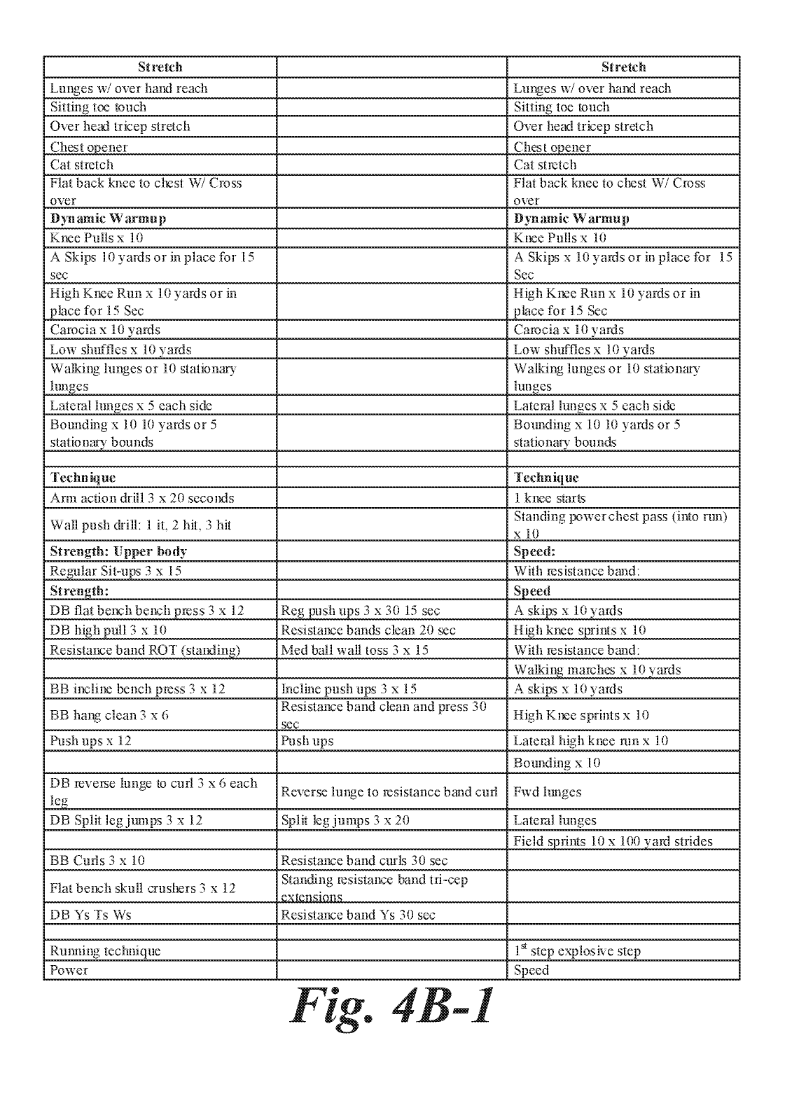

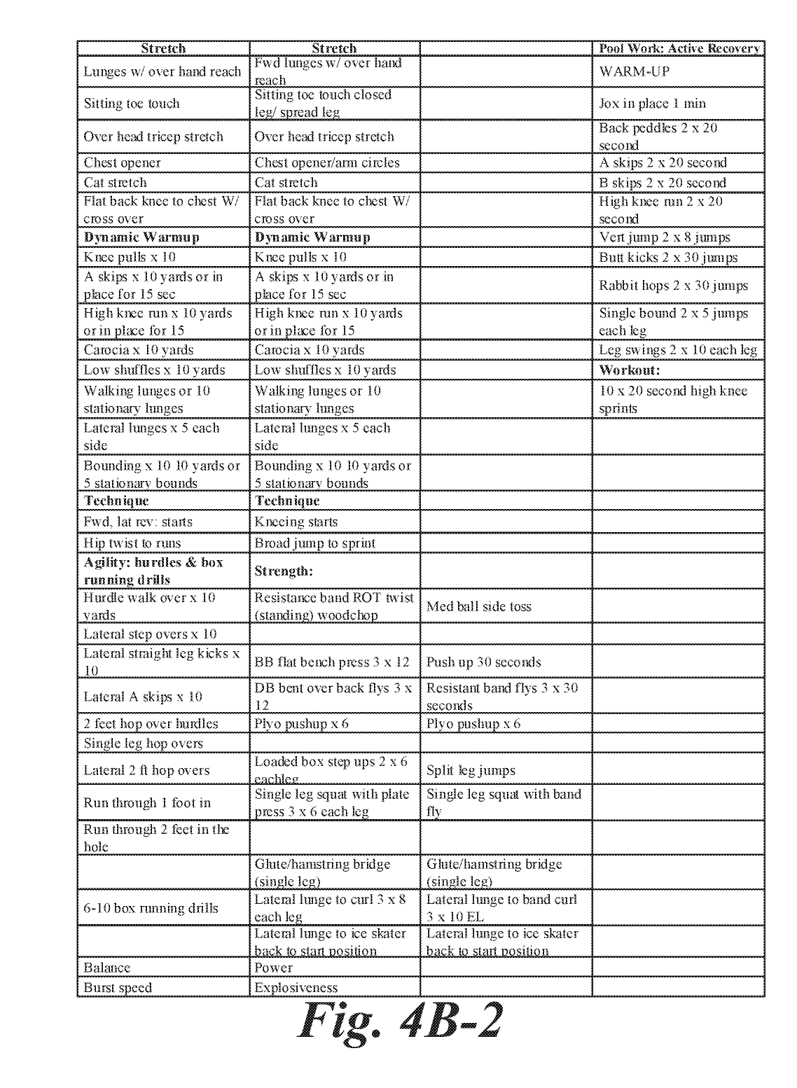

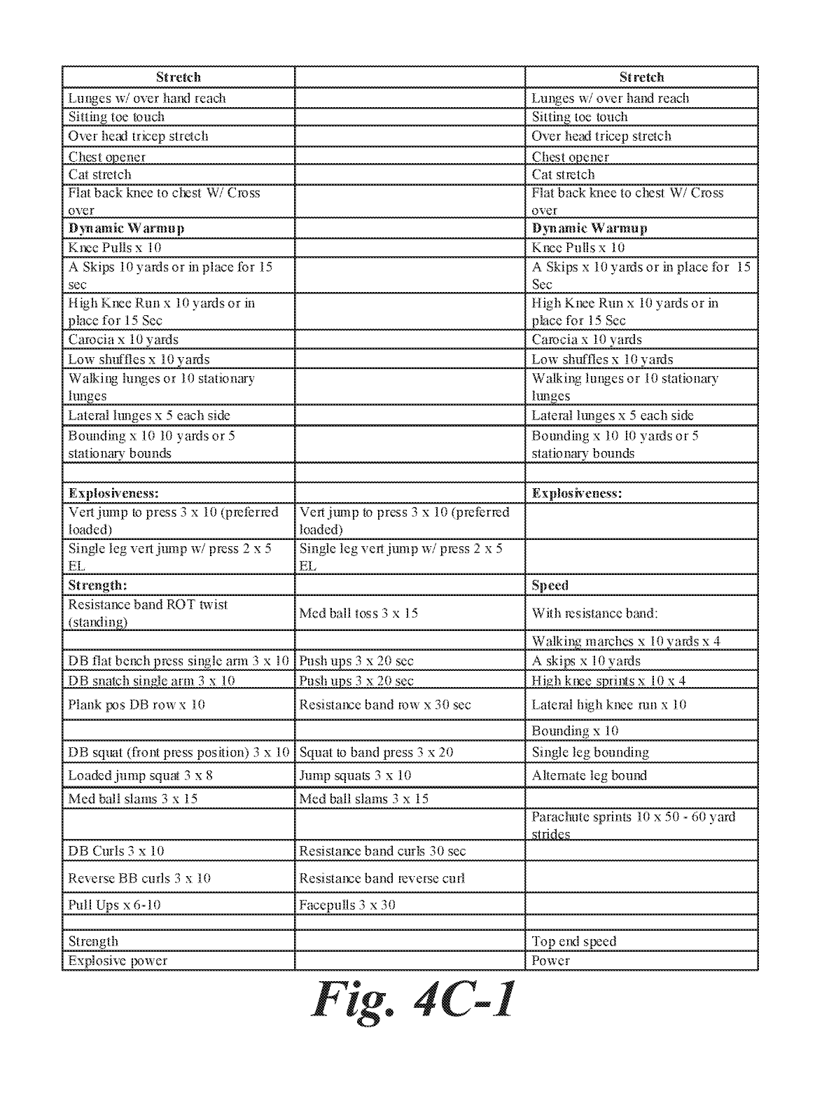

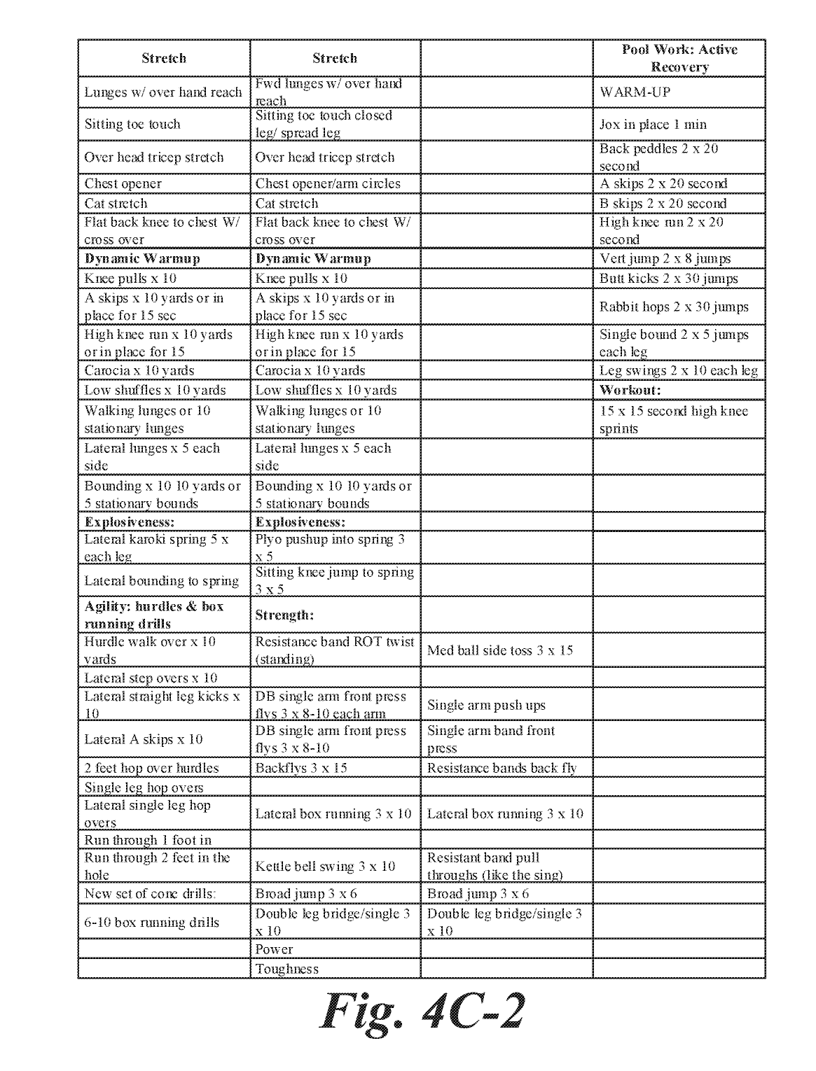

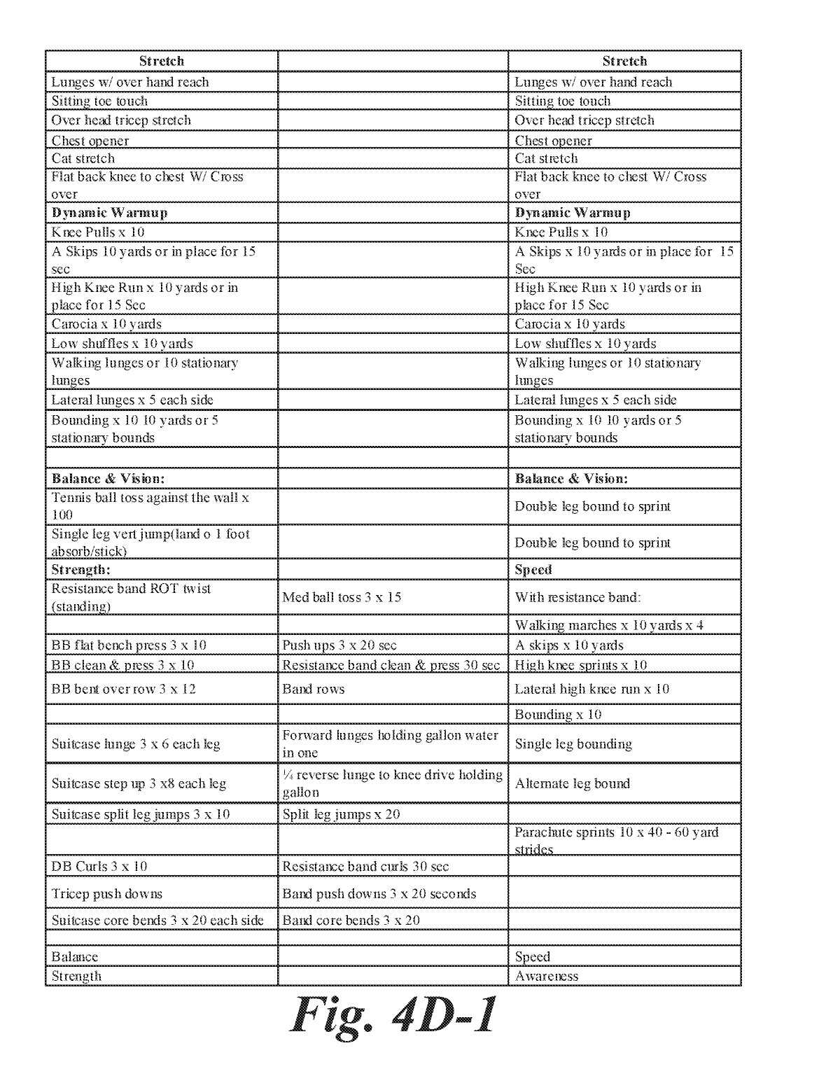

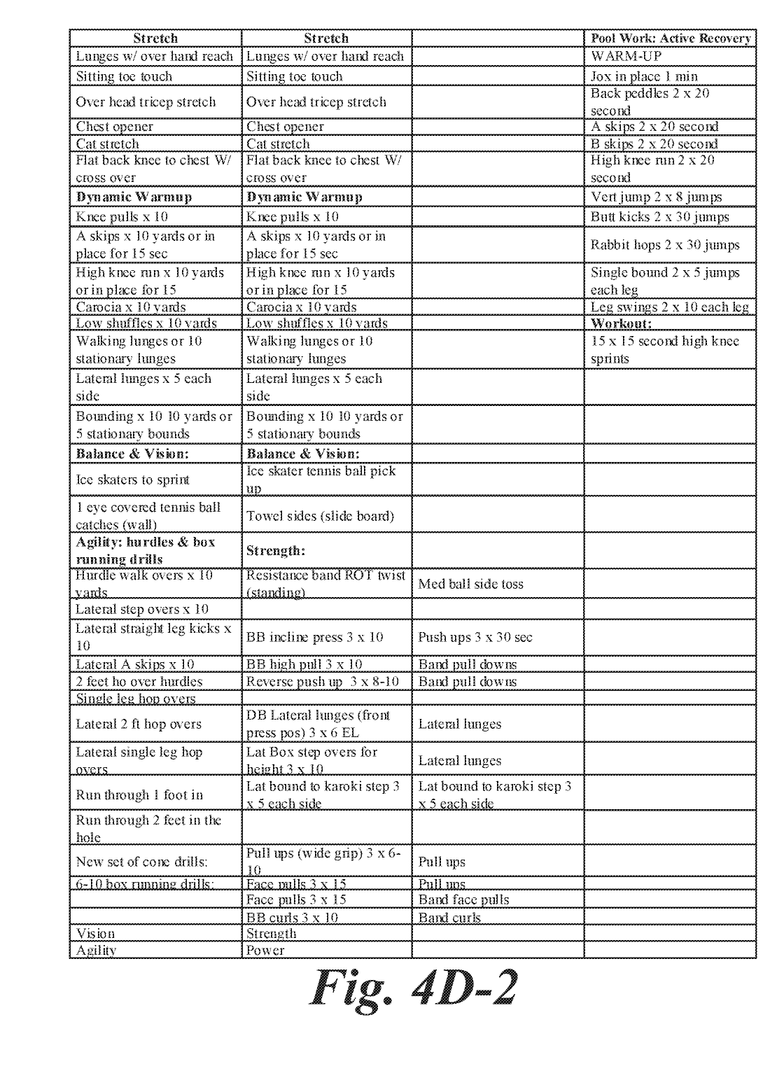

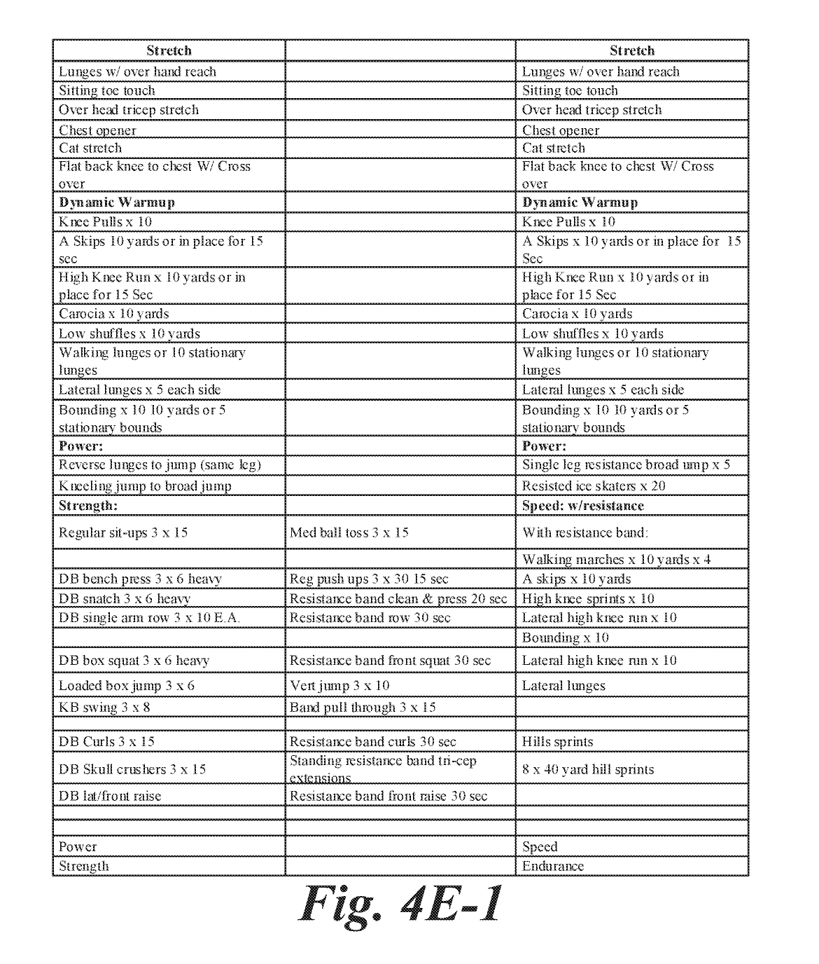

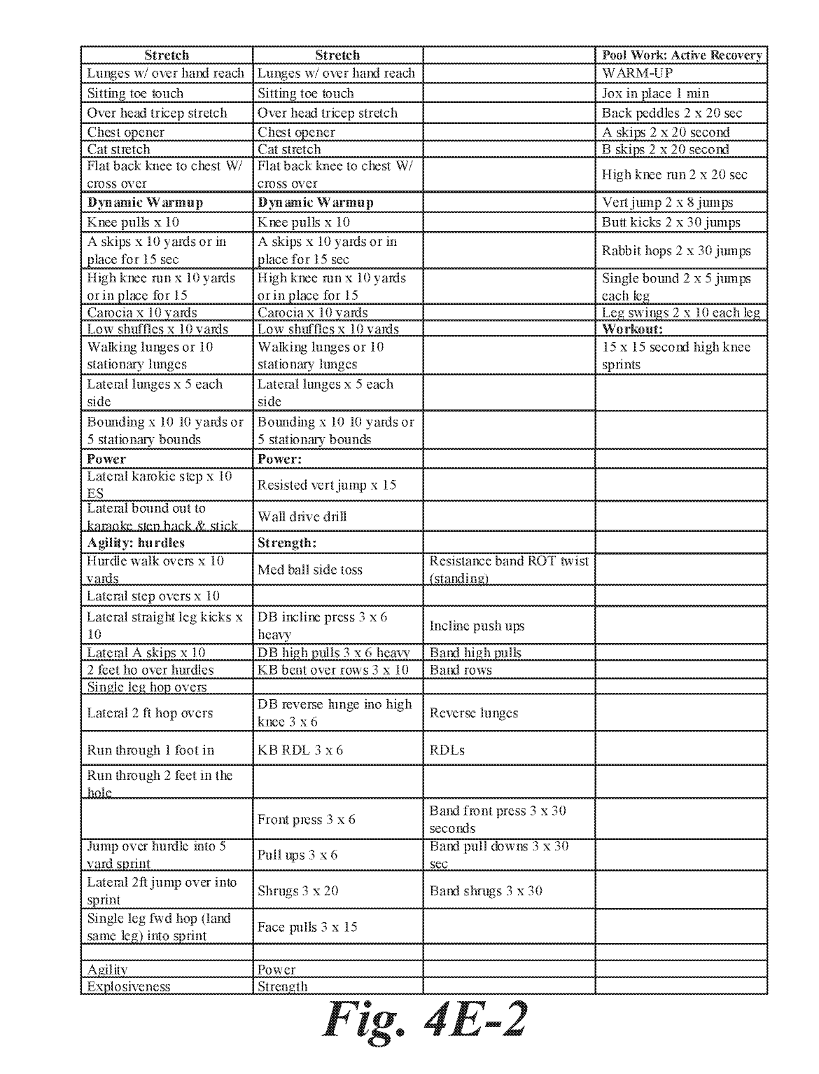

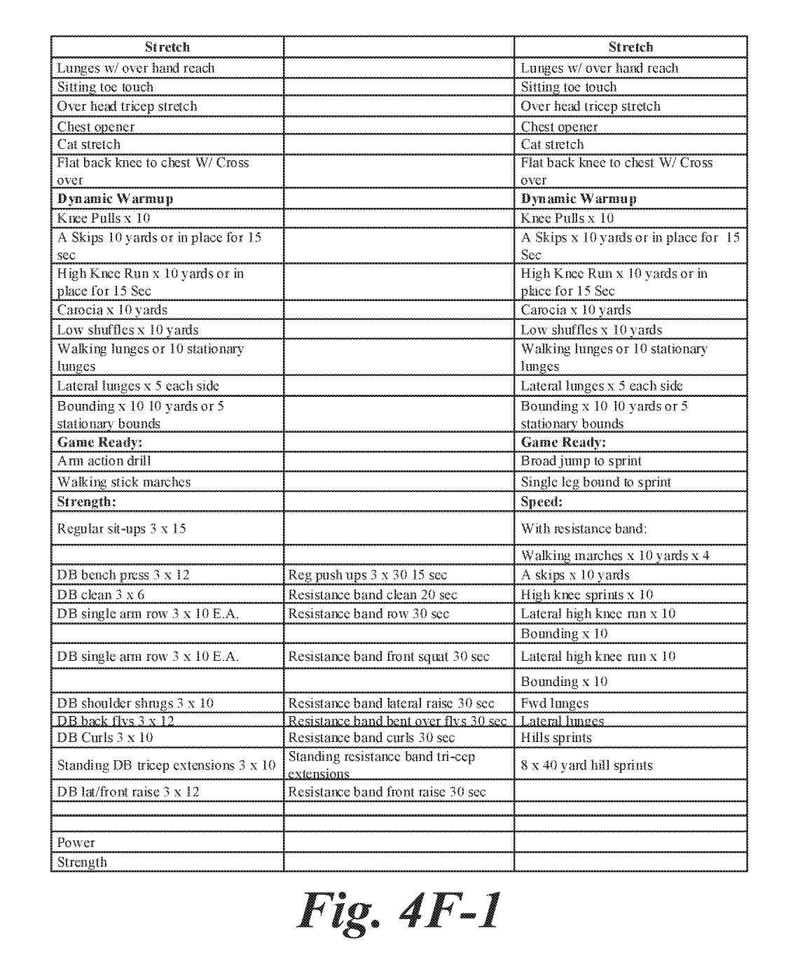

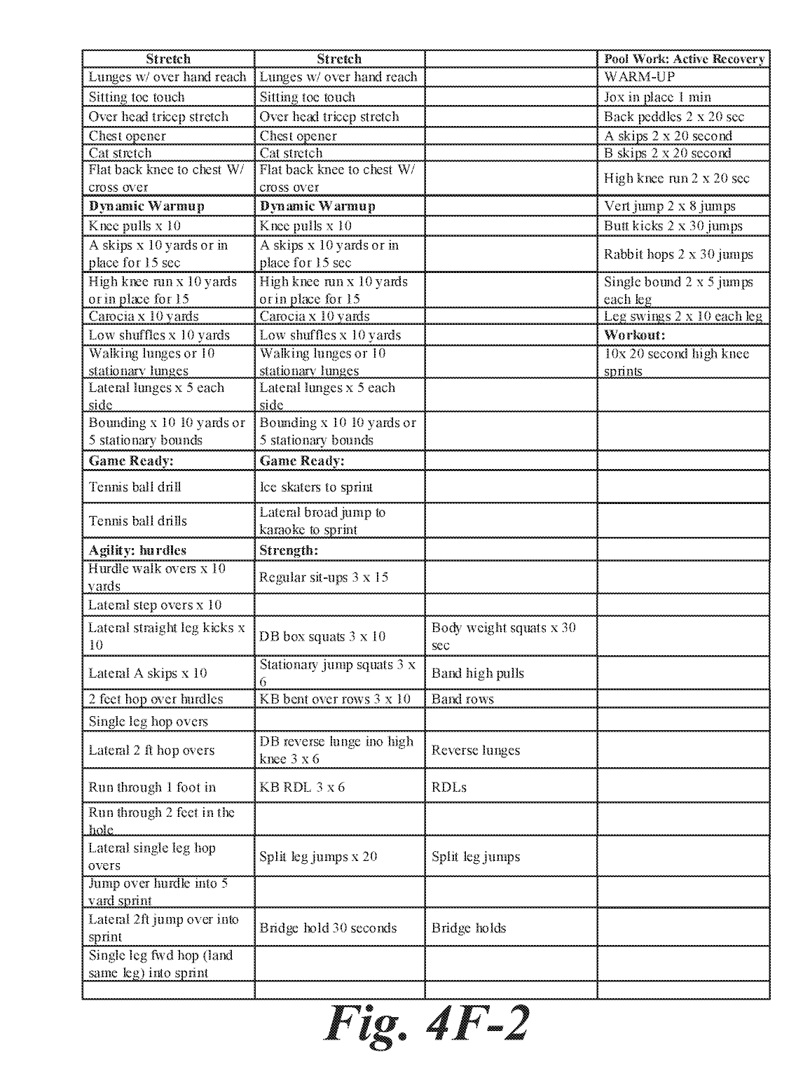

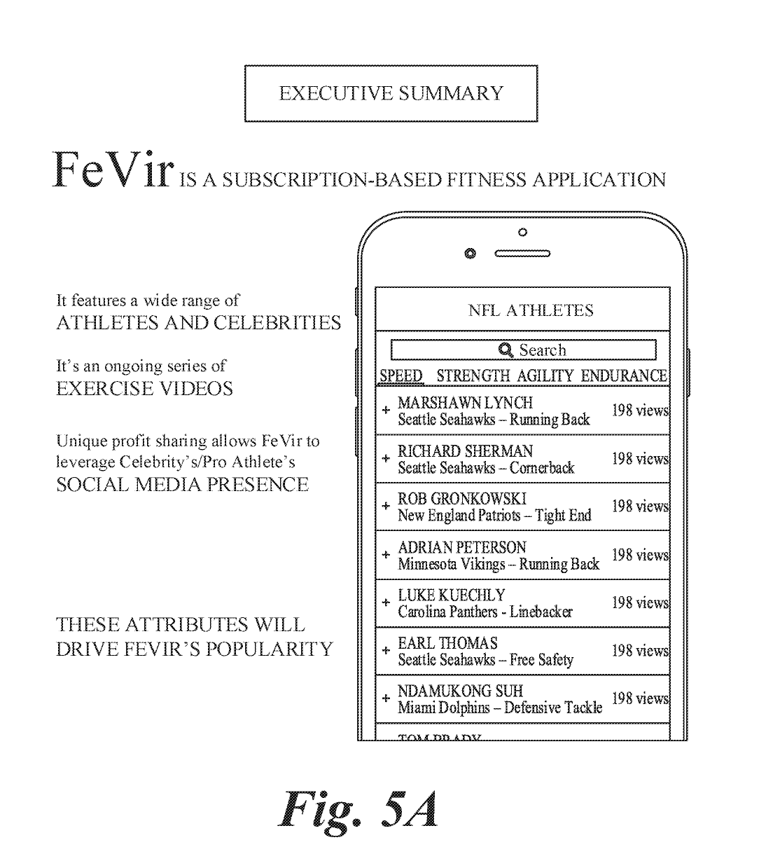

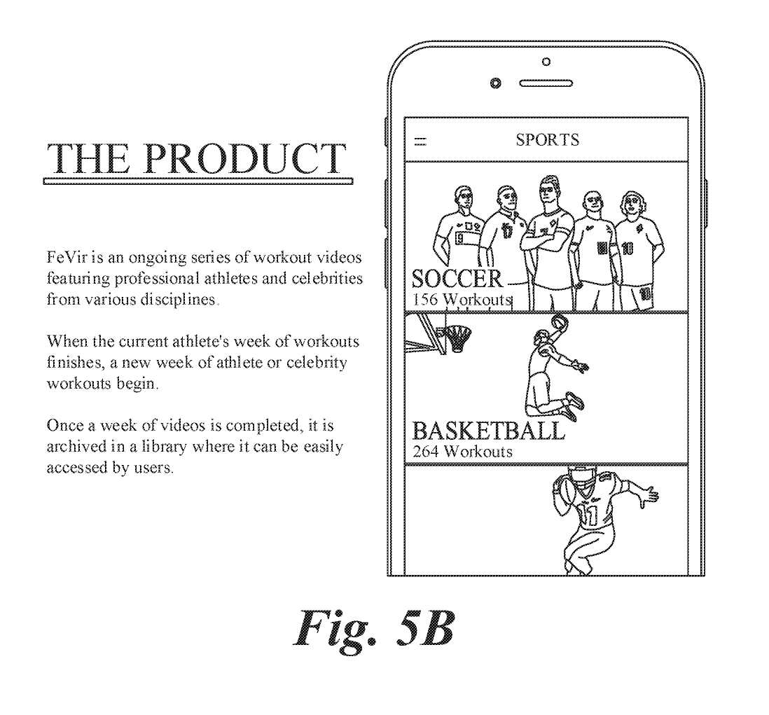

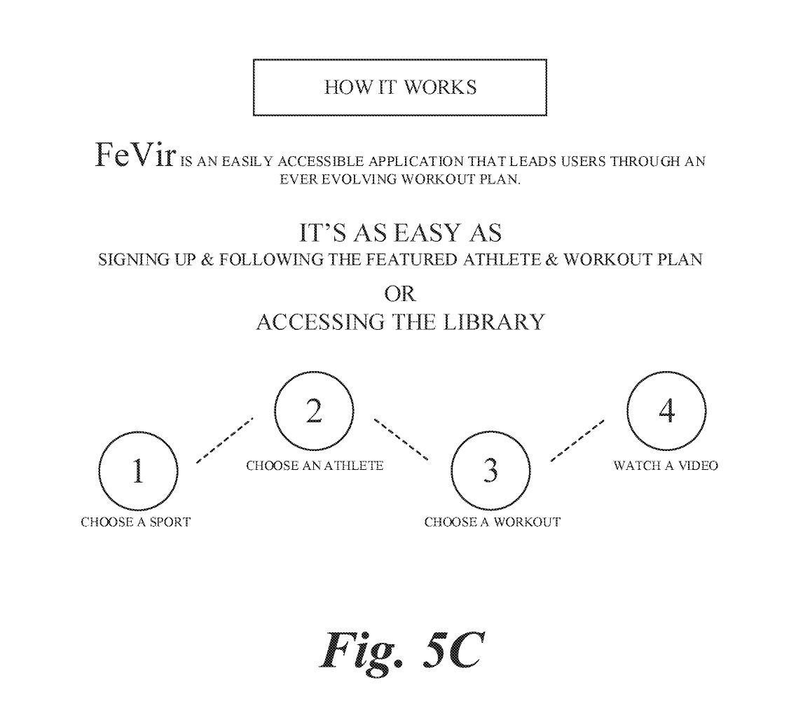

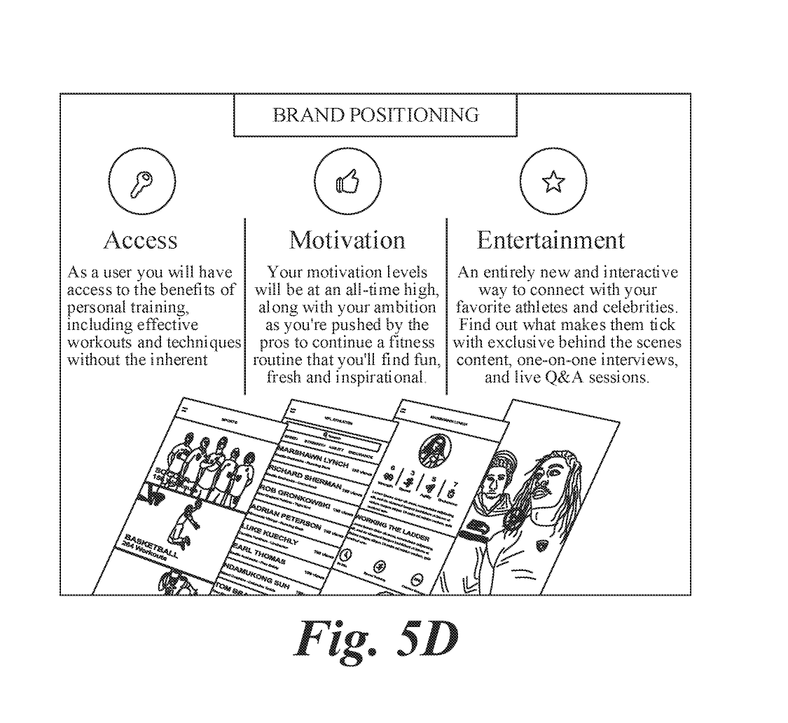

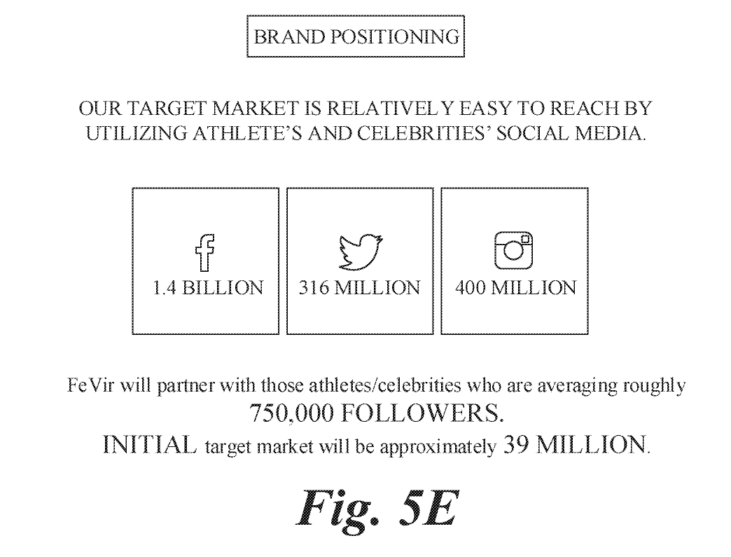

In this embodiment, these fitness programs are delivered to the user by top tier professional athletes via video streaming on, for example, a mobile device. In this preferred embodiment, the program is broad and has multiple athlete hosts from a variety of disciplines. In other embodiments, the programs and/or workouts can be sports specific, as shown in FIG. 5B. In such an embodiment, a sport specific workout would include a program tailored to said sport and would have multiple professional athlete hosts that come from that particular discipline. In another embodiment, general programs are available, such as “up keep” workouts, rehab workouts, cardio workouts, core workouts, etc. In other embodiments, targeted programs such as female-specific or age-specific workouts are also available. One skilled in the art could appreciate the variety of programs, workouts, and other content that could be generated. FIGS. 4A-1 through 4F-2 illustrate, respectively, some of the non-exhaustive examples of different programs in the categories of foundation, technique, explosive, balance, vision, power, and competition.

In particular, FIGS. 4A-1 and 4A-2 illustrate examples of a weeks' worth of workout (e.g., Week 1) consisting of 2 strength routines, 1 speed routine, 1 agility routine, and an active stretch and recovery routine. Each routine itself begins with activated stretch and dynamic warmup. Then, the routines move into their respective program for that particular day within a particular week. Each of these routines can also have exercise variation possibilities, depending on whether the user in the gym or at home and what type of equipment is available.

Similarly, FIGS. 4B-1 and 4B-2 illustrate another example of a weeks' worth of workout (e.g., Week 2); FIGS. 4C-1 and 4C-2 illustrate another example of a weeks' worth of workout (e.g., Week 3); FIGS. 4D-1 and 4D-2 illustrate another example of a weeks' worth of workout (e.g., Week 4); FIGS. 4E-1 and 4E-2 illustrate another example of a weeks' worth of workout (e.g., Week 5); and FIGS. 4F-1 and 4F-2 illustrate another example of a weeks' worth of workout (e.g., Week 6). These embodiments happen to all consist of 2 strength routines, 1 speed routine, 1 agility routine, and an active stretch and recovery routine. Each routine itself begins with activated stretch and dynamic warmup. Then, the routines move into their respective program for that particular day within a particular week. Each of these routines can also have exercise variation possibilities, depending on whether the user in the gym or at home and what type of equipment is available.

As previously discussed, the development of these programs in itself can be very unique. One skilled in the art can appreciate that trainers need to curate their programs according to different end goals. For example, improve sports performance can be very different from traditional weight loss and/or aerobic programs. In a preferred embodiment of the present invention, the purpose and focus of the workouts are to help individual users improve their day-to-day performance in their particular discipline. For example, if the user is a football player, the user will likely choose a football specific workout program to help improve his or her performance.

Moreover, one embodiment of the present invention will offer a new and inventive form of performance training: functional movement. This type of training can allow individuals to see results without having to do high impact exercises that are known to be damaging in traditional weight training. Furthermore, in a preferred embodiment, said sport specific strength/performance training is combined with skills instruction (e.g., pitching, hitting, blocking, shooting, dribbling, speed and agility, catching) and associated drills. In some embodiments, the application platform can be in 2D or can be used in conjunction with VR/AR equipment.

FIG. 5A illustrates one embodiment of the present invention, which is a web-implemented, subscription-based, high production value physical exercise and sports entertainment consumption system and method conveniently implemented on a cellphone, mobile device, or other Internet-accessible display device.

In this embodiment, the user has unprecedented access to professional athletes, as illustrated by FIG. 5B. For example, in one embodiment of the present invention, some of the best performance trainers in the industry curate the platform's workout programs. These programs are then delivered by some of the world's top tier professional athletes and/or their trainers. Each and every day, the user can work out side-by-side with some of the most respected names in sports.

In this embodiment, after signing up and registering a user account, the subscriber has access to a panel of sports-related and/or sports-specific videos having a menu of exercises taught and demonstrated by professional athletes or celebrities, as show in FIGS. 3G and 5B. Then, as shown in FIG. 5C, the subscriber can (a) select a featured athlete and a workout plan; and/or (b) access the video library to choose a sport, then choose an athlete or other qualified instructor, and then select a particular workout demonstrated by the subscriber-chosen instructor. Next, the subscriber watches the selected video, mimics the video, and records the subscriber mimic video. The user can have the option of forwarding the recordation by wireless means back to the application, which may ultimately reach the subscriber-chosen instructor for evaluation. Or, alternatively, the user may measure and test his or own performance regularly through the features available on the application platform.

As illustrated in FIG. 5D, embodiments of the present invention optionally and/or advantageously integrate access, motivation, entertainment, and technology to cultivate a new platform for achieving the following (including, but not limited to): (i) access to the benefits of personal training, including effective workouts and techniques; (ii) fun, fresh, inspiration and motivation to continue a fitness routine when the user is pushed by role models such, for example, professional athletes; (iii) a new and interactive way to connect with role models such as, for example, professional athletes through exclusive behind-the-scenes content, one-on-one-interviews, and live Q&A sessions; (iv) sports entertainment; (v) athlete expression; (vi) education; (vi) and results.

Other embodiments concern amplifying a qualified trainer's exposure to other subscriber candidates by utilizing and leveraging social media accounts. FIG. 5E illustrates one embodiment which utilizes the social network. The effects of the social network can be seen in the following example:

If there are 52 athletes utilizing the platform, and each athlete has 750,000 social media followers, then the platform would have a reach to 39 million followers (and approximately 29 million qualified subscribers if 75% of those followers are users likely to subscribe to the platform). Assuming a 0.9% capture rate based on the number of posts required from each athlete (which means 261,000 potential subscribers) with 50% retention rate, the platform would be able to retain 130,000 subscribers.

As such, one embodiment of the present invention allows a user—in this case, for example, a professional athlete—to connect with other users (e.g., fans) to build their brands and raise awareness on issues that are closest to them. Providing a platform to highlight awareness of, for example, a charity is an optionally advantageous feature of this embodiment. Some of the awareness elements will come into play in the original content portion, but one or more embodiments of the invention can also facilitate athletes to, for example, host charity events (e.g., camps, galas, fundraisers, etc.) by or for a user (e.g., an athlete or a company). In other embodiments, the present invention could use as, for instance, a forum for announcing retirement, a sneak peek at a new product, a place to speak freely on hot topics, platform to debut a show, or simply a place to connect socially with fans. Embodiments of the present invention can enable, for example, athletes to be able to promote themselves in all aspects of their lives. Additionally, it can enable other users to support the athletes too. For example, embodiments of the present invention could facilitate financial grants to help athletes transition from sports to the next phase of their lives, or other programs such as career counseling, job placement, therapy if needed, networking opportunities, incubation space for athlete's startups, and more.

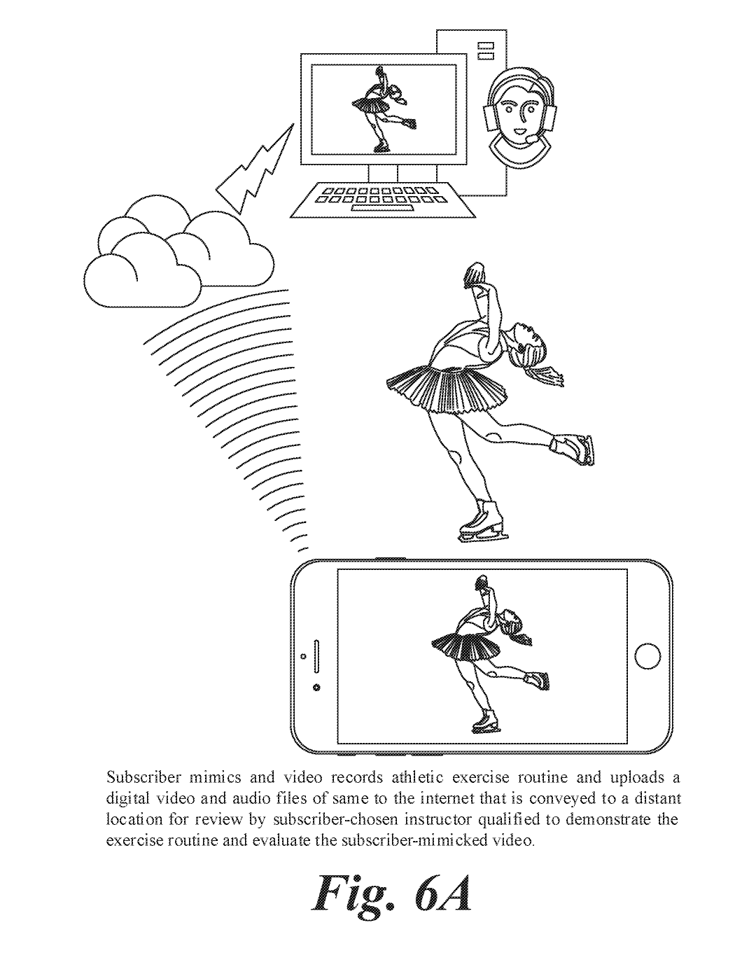

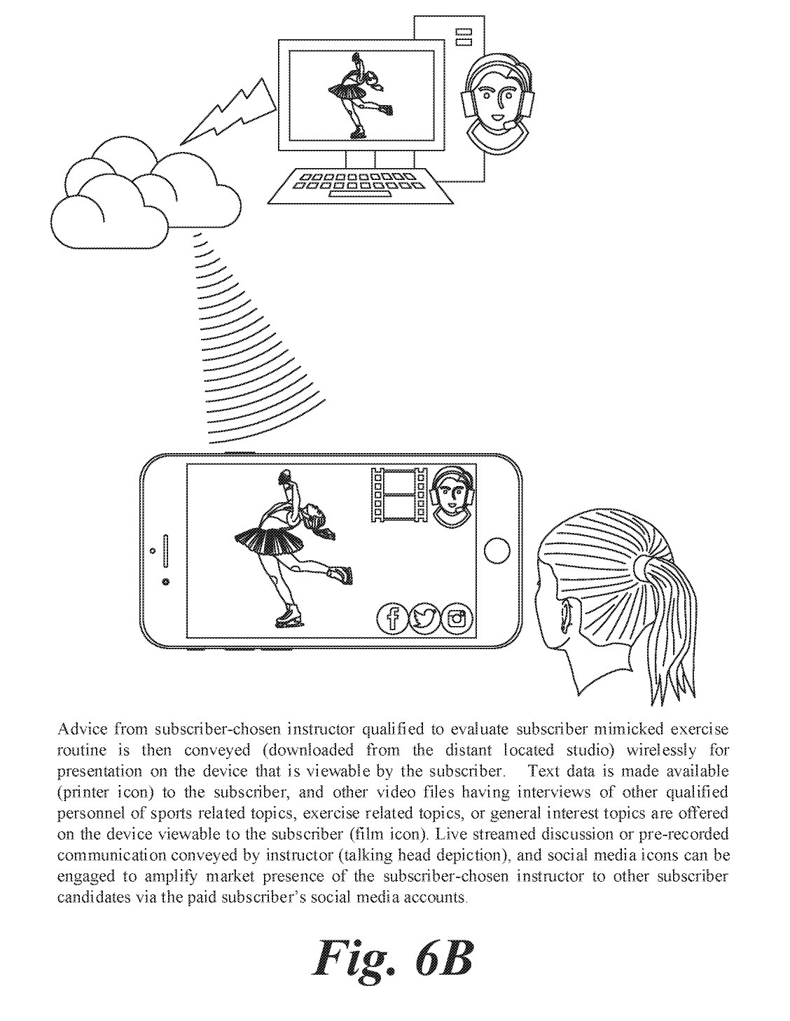

FIGS. 6A-6B illustrate a system embodiment not using motion, force and physiologic sensors. In FIG. 6A, the user mimics and video records athletic exercise routine and uploads a digital video and audio files of the same to the Internet that is conveyed to a distant location for review by the user-chosen instructor and/or a qualified personnel to demonstrate the exercise routine and evaluate the user-mimicked videos. In FIG. 6B, advice from the user-chosen instructor and/or qualified personnel to evaluate the user-mimicked exercise routine is then conveyed (downloaded from the distant located studio) wirelessly for presentation on the device that is viewable by the user. In this embodiment, text data is made available (printer icon) to the user, and other video files having interviews of other qualified personnel of sports related topics, exercise related topics, or general interest topics are offered on the device viewable by the user (film icon). Live streamed discussion or pre-recorded communication conveyed by the user-chosen instructor and/or qualified personnel (talking head depiction), and social media icons can be engaged to amplify market presence of the subscriber-chosen instructor (e.g., professional athlete) to other third parties (including potential users and subscriber's).

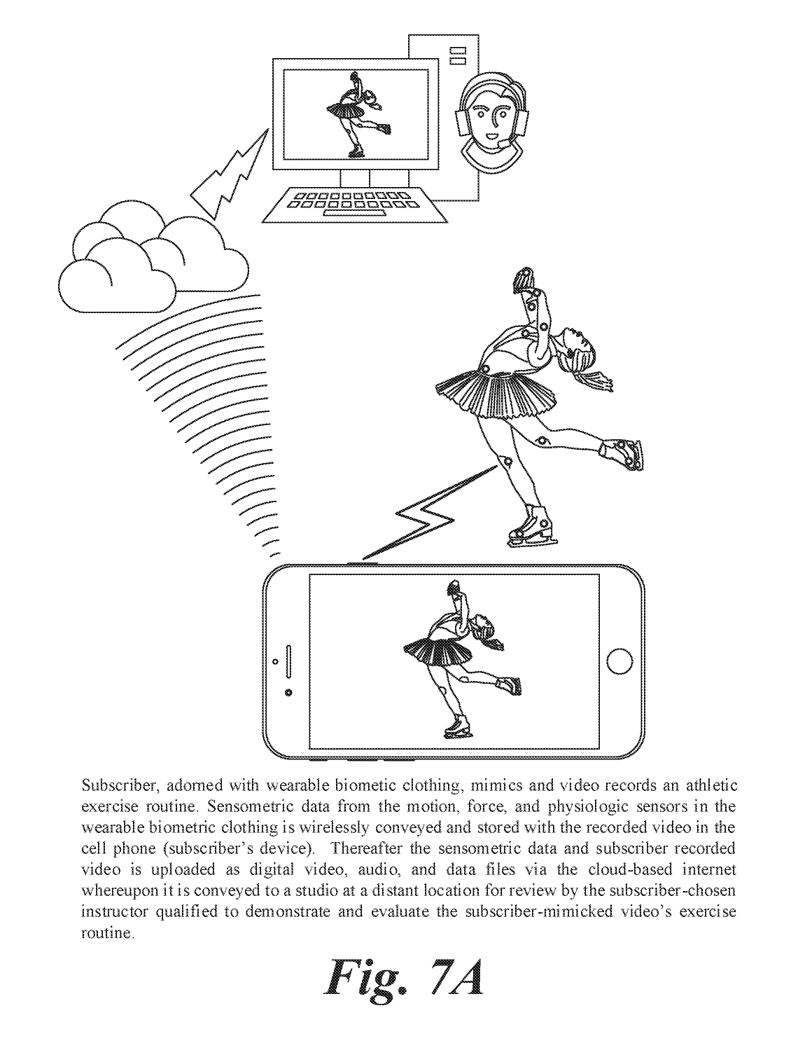

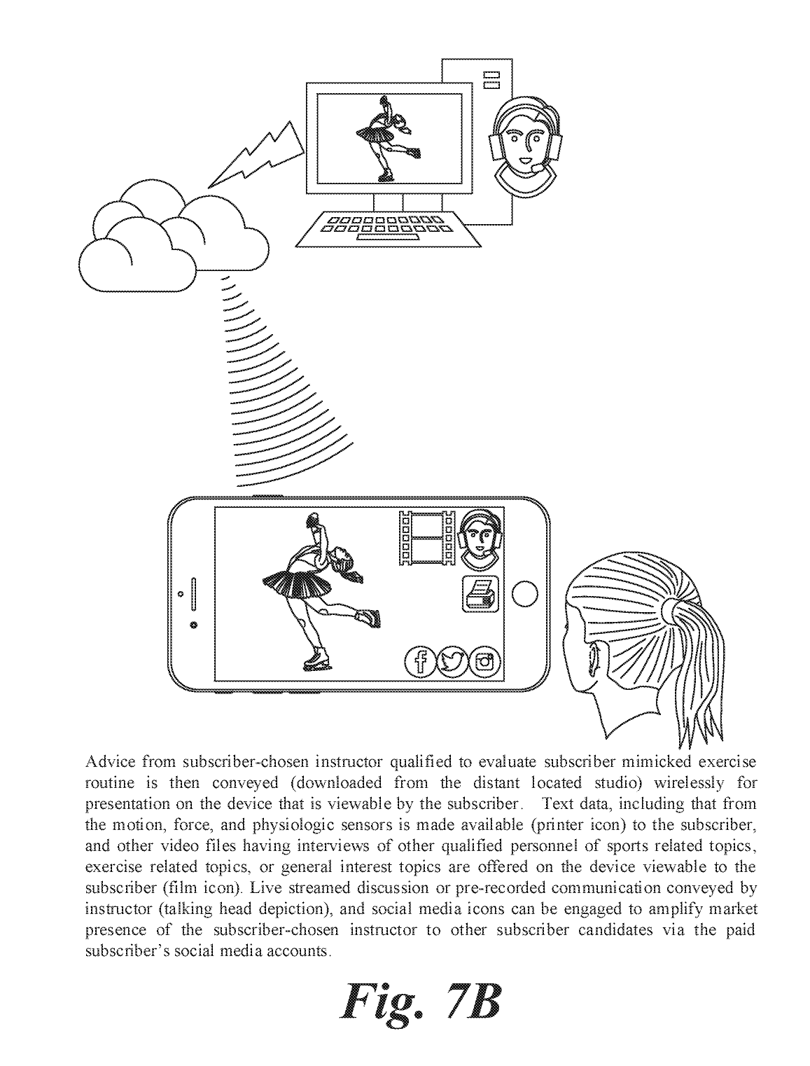

FIGS. 7A-7B illustrate a system embodiment using motion, force, and physiologic sensors. In FIG. 7A, the user, who is adorned with wearable biometric clothing, mimics and video records an athlete exercise routine. Sensometric data from the motion, force, and physiologic sensors in the wearable biometric clothing is wirelessly conveyed and stored with the recorded video in the user's device (e.g., cell phone). Thereafter, the sensometric data and user recorded video is uploaded as digital video, audio, and data files via the cloud-based Internet whereupon it is conveyed to a studio at a distant location for review by the user-chosen instructor and/or qualified personnel to demonstrate and evaluate the user-mimicked video's exercise routine. In FIG. 7B, advice from the user-chosen instructor and/or qualified personnel is then conveyed (downloaded from the distant located studio) wirelessly for presentation on the device that is viewable by the user. In this embodiment, text data, including that from the motion, force, and physiologic sensors, is made available (printer icon) to the user, and other video files having interviews of other qualified personnel of sports related topics, exercise related topics, or general interest topics are offered on the device viewable by the user (film icon). Live streamed discussion or pre-recorded communication conveyed by the user-chosen instructor and/or qualified personnel (talking head depiction), and social media icons can be engaged to amplify market presence of the subscriber-chosen instructor (e.g., professional athlete) to other third parties (including potential users and subscribers).

In another embodiment of a fitness subscription program system, comprises: (1) a server, wherein the server stores a series of microprocessor-executable videos featuring at least one person qualified to demonstrate an exercise routine; (2) a portable device capable of (a) presenting visual and/or aural information from the microprocessor-executable exercise videos, recording, and transmitting data, (b) recording the subscriber mimicking the exercise routine to produce a subscriber mimicked video, the subscriber mimicked video having at least one of a video file, an audio file, and an alphanumeric data file, and (c) transmitting the subscriber mimicked video to the server for processing and analysis and receiving fitness data based on the analysis. In particular, at least one person can include a professional athlete, a celebrity, and a qualified amateur.

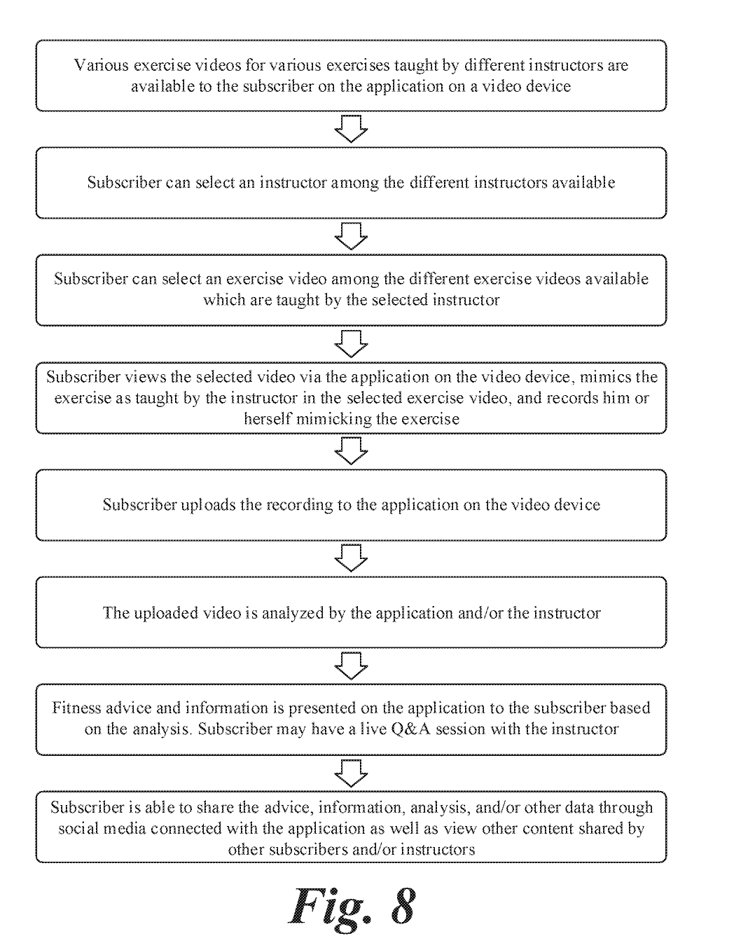

FIG. 8 is a flowchart illustrating a method embodiment not using motion, force and physiologic sensors. FIG. 8 illustrates a microprocessor executable method of providing a fitness subscription program to a subscriber, the method comprising the steps: (1) making available at least one exercise video viewable by a subscriber on a video device, the at least one exercise video demonstrated by at least one person qualified to demonstrate at least one exercise; (2) choosing by the subscriber an instructor from the at least one person; (3) choosing by the subscriber an exercise demonstrated by the instructor from the at least one exercise; (4) mimicking by the subscriber the exercise demonstrated by the instructor; (5) recording the subscriber mimicked exercise by the video device to produce a subscriber mimicked video, the subscriber mimicked video having at least one of a video file, an audio file, and an alphanumeric data file; (6) sending the subscriber mimicked video to a studio configured to display the subscriber mimicked video to the instructor; (7) analyzing the video file, the audio file, and the alphanumeric data file by the instructor to produce advice regarding the subscriber performance in the subscriber mimicked video; (8) presenting the advice onto the video device viewable by the subscriber with social media icons engaged by the subscriber to amplify market presence of the instructor and the fitness subscription program.

In one embodiment, then the advice includes at least one of video communication, instructor conveyed video communication, instructor conveyed audio communication. The instructor conveyed video communication can also include at least one of live discussions between the instructor and the subscriber and pre-recorded communications from the instructor to the subscriber. Similarly, the instructor conveyed audio communication can include at least one of live discussions between the instructor and the subscriber and pre-recorded communications from the instructor to the subscriber. In addition, the video communication can also include providing exercise related information and non-exercise related information.

In another embodiment, at least one person qualified to demonstrate at least one exercise includes professional athletes, celebrities, and trained amateurs.

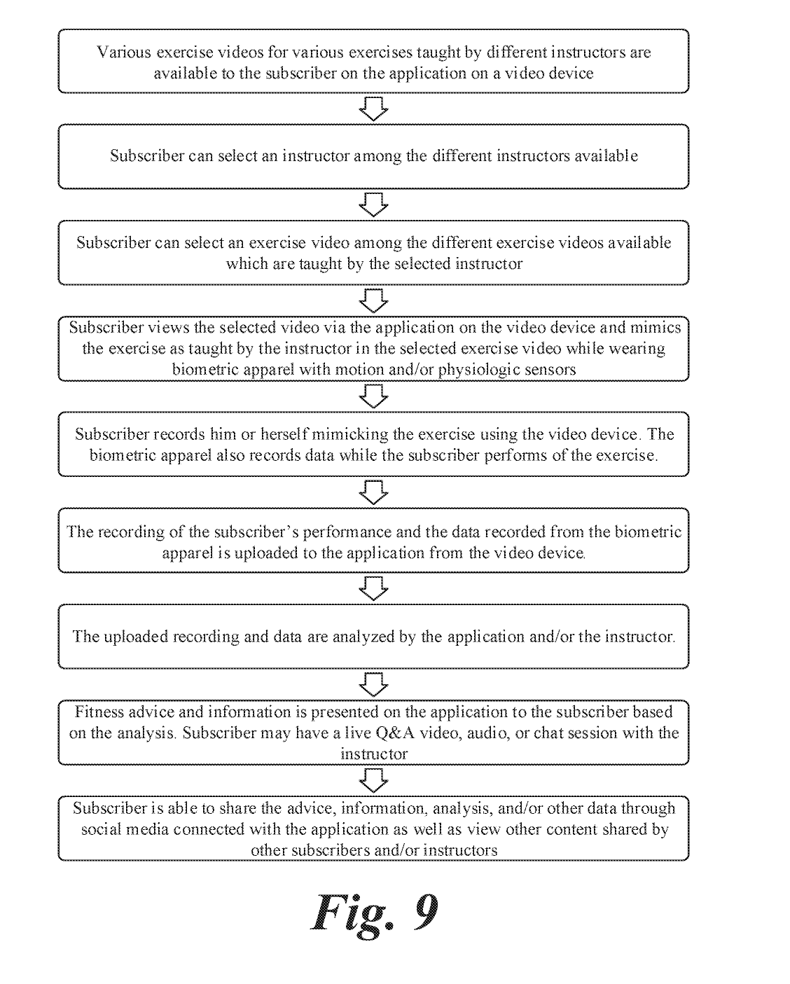

FIG. 9 is a flowchart illustrating a method embodiment using motion, force, and physiologic sensors. FIG. 9 illustrates a microprocessor executable method of providing a fitness subscription program to a subscriber, the method comprising the steps: (1) making available at least one exercise video viewable by a subscriber on a video device, the at least one exercise video demonstrated by at least one person qualified to demonstrate at least one exercise; (2) choosing by the subscriber an instructor from the at least one person; (3) choosing by the subscriber an exercise demonstrated by the instructor from the at least one exercise; (4) fitting a biometric apparel on the subscriber, the biometric apparel having a plurality of motion and/or physiologic sensors; (5) mimicking by the subscriber the exercise demonstrated by the instructor; (6) recording the subscriber mimicked exercise by the video device to produce a subscriber mimicked video, the subscriber mimicked video having at least one of a video file, an audio file, and an alphanumeric data file, the alphanumeric file derived in part from signals conveyed by the plurality of motion and/or physiologic sensors to the video device; (7) sending the subscriber mimicked at least one exercise video to a studio configured to present the subscriber produced video viewable by the at least one person; (8) analyzing the video file, the audio file, and the alphanumeric data file by the instructor to produce advice regarding the subscriber performance in the subscriber mimicked video; and (9) presenting the advice onto the video device viewable by the subscriber with social media icons engaged by the subscriber to amplify market presence of the instructor and the fitness subscription program.

In one embodiment, the advice includes at least one of video communication, instructor conveyed video communication, instructor conveyed audio communication, and alphanumeric communication regarding measurements from the motion and/or physiologic sensors. Additionally, the instructor conveyed video communication can include at least one of live discussions between the instructor and the subscriber and pre-recorded communications from the instructor to the subscriber. Similarly, the instructor conveyed audio communication can include at least one of live discussions between the instructor and the subscriber and pre-recorded communications from the instructor to the subscriber. In this embodiment, the video communication can include providing exercise related information and non-exercise related information.

In another embodiment, at least one person qualified to demonstrate at least one exercise includes professional athletes, celebrities, and trained amateurs.

In another embodiment, a microprocessor executable method of providing a fitness and entertainment platform to a subscriber comprises the steps of: (1) making available at least one exercise video viewable by a subscriber on a video device, the at least one exercise video demonstrating at least one exercise performed by at least one person qualified to perform the at least one exercise; (2) receiving from the subscriber a selection of the at least one person as an instructor; (3) receiving from the subscriber a selection of an exercise of the at least one exercise demonstrated by the instructor; (4) making available and viewable by the subscriber at least one entertainment video before, during, and/or after the subscriber mimics the exercise demonstrated by the instructor. The at least one entertainment video can include at least one of a behind-the-scenes video and a licensed broadcast. Additionally, the at least one person qualified to perform the at least one exercise can include professional athletes, celebrities, and trained amateurs. Another optionally advantageous feature is that the at least one exercise video is curated using the theory of functional movement.

In yet another embodiment of the present invention, a microprocessor executable method of providing a fitness and entertainment platform to a subscriber comprises the steps of: (1) making available at least one exercise video viewable by a subscriber on a video device, the at least one exercise video demonstrating at least one exercise performed by at least one person qualified to perform the at least one exercise; (2) making available at least one entertainment video viewable by a subscriber on a video device, the at least one entertainment video featuring the at least one qualified person; (3) receiving from the subscriber a s-election of the at least one person as an instructor; (4) receiving from the subscriber a selection of an exercise of the at least one exercise demonstrated by the qualified person; and (4) receiving from the subscriber a selection of an entertainment video featuring the qualified person. The sport-specific purpose training includes skills instructions and associated drills.

In still another embodiment of the present invention, a fitness subscription program system comprises: (1) a server, wherein the server stores (a) a series of microprocessor-executable exercise videos featuring at least one qualified person to demonstrate an exercise routine, and (b) at least one microprocessor-executable entertainment video featuring the qualified person; and (2) processor-executable instructions that, when executed by a portable device, enable the portable device to perform a method comprising the steps of (c) presenting visual and/or aural information from the microprocessor-executable exercise video and entertainment video from the server through wireless transmission, and (d) recording data relating to the subscriber mimicking the exercise routine. In this embodiment, the virtual reality equipment for displaying, transmitting, and recording all microprocessor-executable data.

The following steps illustrate one way a user could interact with a preferred embodiment of the present invention: (1) download the application; (2) watch an introductory video; (3) sign up/register/subscribe to the platform; (4) start a workout program or watch other streaming content; (5) participate in a fitness test (5 exercises); (6) begin his or her day 1 workout; (7) watch bonus material; (8) workout 5 days a week for 6 weeks; (9) continue to watch other streaming content; (10) participate in live Q&As with the athlete; (11) start another program at the end of 6 weeks (e.g., sport specific/women's/men's/upkeep/core).

Embodiments of the present invention can utilize, for example, existing or later-developed technology to build and support the disclosed methods and systems. A non-exhaustive list of one or more examples of current technologies that one skilled in the art may utilize are provided below:

Platform Related:
Laravel 5.2
MySql
HTML 5
CSS 3
Js/Jquery
Native Swift iOS Client

High Level Server Requirements
AWS Account—EC2 Required|S3 Required
Landing Page—Fevir Static Site
Webhost: Site 5
IP Address: 108.XXX.XXX.84
FTP Hostname: fevir.ktcdev.com
FTP Username: Fevir
FTP Password: Fevir
HockeyApp for iOS Deployment
Enterprise Level Apple Developer Account

Marketing Website:
Phase 1: Static HTML

IOS Client:
User Registration
Login: Manuel/Facebook
Create Account:
User Dashboard
Settings
Payment Flow
Video Flow
Custom Video Integration
Take Test

Push Notifications:
Need to be DEFINED

Super ADMIN
Manage User
List Users—Search/Filter
View User
View User Billing
Analytics v1
Video Views
Last Login
Active Sessions/Month
Edit User
Change User Status
Reset User Password
Send Email
Manage Program

Payment Gateway:
Braintree payment gateway: Sandbox

Transactional Emails
Mandrill

API's Integrated:
Facebook SDK
Twitter SDk

A non-exhaustive list of one or more embodiments of the invention are provided below:

Fitness App:
a. Sport specific performance training.
   i. Online delivery model
   ii. Mobile access anytime/anywhere
   iii. Video library
   iv. Streaming
b. Fitness training designed by professional trainers delivered by professional athletes.
   i. Takes you in and out of the gym
   ii. New age/low impact
   iii. Functional training (training motion not muscles)
   iv. Fresh content delivered at regular intervals
   v. Live workouts
c. UI/UX design (content delivery and flow)

Production Platform
a. Original content
   i. Interviews
      1. This could be a 60 minutes style sit down with an athlete(s) from a variety of disciplines
   ii. Docuseries/reality
      1. This could be something similar to HARD KNOCKS or ALL OR NOTHING. We have one waiting in the wings already a called FREE AGENTS.
         a. Free Agents, is about understanding the real life challenges and hurdles of being a professional athlete. It focuses on three separate athletes and their personal lives. A young gun who is struggling to hold onto his dream. A superstar who is negotiating a big deal and living the life most people assume every pro athlete leads, and a veteran who is trying to remain relevant in a job where you're ‘old’ at 30. Unlike ‘Hard Knocks’ we follow the athletes home to their families and into their off the field day to day lives. We of course also see the negotiation process they navigate during their free agency, but the show is really about the people, not the sport. The audience will get to know and understand the athlete, his family, his dreams and his fears.
   iii. Scripted series
      1. Think along the lines of NBC's Friday Night Lights. That is also an example of existing content that we might attempt to license
   iv. Feature films
      1. These will be sports films Fevir produces and distributes in house based on scripts acquired or developed based on both fictional and non-fictional events.
   v. Live stream
      1. We want to live stream sporting events. It could be particular NFL games to Rugby or Soccer matches. These sports could be regional, national or international. They could be professional or even semi pro.
      2. We also hope to stream live magazine shows similar to the studio shows that we see regularly on the likes of ESPN, FOX Sports etc. Our shows would be catered to our brand and our audience.
   vi. Instructional videos
      1. We plan on doing instructional videos (pitching, hitting, blocking, shooting, dribbling, speed & agility, catching etc.) and associated drills. This could be viewed in 2d or VR/AR as part of our unique combination of technology
   vii. Athlete interaction
      1. This could be Q&As where users submit questions to our athletes during a brief live stream where they answer anything and everything
      2. This could also be in reference to in person camps that Fevir puts on and promotes.
b. Athlete produced content
   i. Creative content
      1. Whatever our athletes want to do (documentary's, interviews, cartoons etc.)
   ii. Announcements
      1. For example: Tom Brady announces his retirement exclusively with in the Fevir app.
   iii. Interviews
      1. Athlete on athlete interviews. Labron interviews Michael Jordan
   iv. Day-in-the-life
      1. Falls under the docuseries category, but if an athletes has something they feel strongly about showcasing then they will be able to do so with in the app

Distribution and Streaming
a. Movies (i.e. Field of Dreams, Any Given Sunday, Hoosiers, Major League, The Natural, Miracle, Friday Night Lights etc.)
b. TV Series (i.e. Coach, Hard Knocks, Friday Night Lights, Blue Mountain State, Celebrity Deathmatch, Guts, The Hoop Life, Rocket Power, The Contender etc.)
c. Live (events/games/matches/races/etc.)
d. Replays (events/games/matches/races/etc.)

Technology
a. Fitness tracking
   i. Automated real-time
   ii. Automated GPS Mapping
      1. Similar to map my run but with our tech within our platform
   iii. Bio-signal monitoring
      1. For example, heart rate, bmi scanning etc.
b. Virtual reality
   i. VR allows all sorts of entertainment and instructional possibilities. Imagine standing in a batter's box on a baseball field and having Clayton Kershaw throw you batting practice, but you're doing this from the comfort of your home or local park thanks to VR
c. Smartwatch integration
   i. Integrating some existing technology with in phones (i.e. apple health) and creating a plug in for it with in our app Fevir. That way they can feed each other based on users fitness goals.

Gaming
a. Sports Related Games (i.e. Tecmo Bowl, Blades of Steel, Punch Out, NBA Jam, Fifa etc.) all of which can be consumed on, for example, a mobile device.
   i. We could develop, acquire or repurpose video games that can be played with in our app

Apparel
a. Style apparel
   i. For example hats, shirts, polos, tanks, pants, shorts, shoes, socks, watches, sunglasses
b. Wearable biometric clothing
   i. For example, heart rate monitors, spanx with BMI/Impact tracking, watches, shoes with gps trackers and impact monitoring
c. Therapeutic clothing/devices
   i. For example gloves, various braces, arch supports, shirts, shorts
d. Performance apparel
   i. Any type of apparel with a unique blend of materials that allow for improved performance
e. Footwear
   i. Fevir shoes of all types. (i.e. tennis, running, cross trainers, lifestyle, gym etc.)
f. Headwear

Food and Beverage
a. Energy Drink
   i. Fevir Energy Drinks
b. Nutrition Regimen (sport specific, athlete specific, training diets, maintenance diets, in season/off season nutrition)
   i. Like TB12. Healthy, sport specific prepared meals that could essentially be bought at a store or delivered to your home.
c. Energy Bars
   i. Like power bars or cliff bars, but made by Fevir and our nutrition scientists who aim to aid and improve performance.
d. Supplements
   i. Protein powders, pre lift supplements, water, hydration replenishes, creatines, BCAAs, CLAs and other vitamins created t by Fevir's nutrition scientists who aim to improve sports performance and health

Philanthropy
a. Fundraising
   i. Charity events to raise money for injured athletes, medical studies for things like CTE or anything else that is near and dear to the hearts of the Fevir Family
b. Sports Camps
   i. Sports camps for kids put on by Fevir and hosted by our trainers and athletes
c. Entrepreneur Camps
   i. Camps that give access to kids and young adults who are trying to start companies or cultivate ideas without the means to do so. It's not unlike the idea of Y Combinator or other incubators
d. Special Projects (outside of sports but utilizing athlete celebrity)

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

We claim:

1. A microprocessor executable method of providing a fitness and entertainment platform to a subscriber, the method comprising:
making available at least one exercise video viewable by a subscriber on a video device, the at least one exercise video demonstrating at least one exercise performed by at least one person qualified to perform the at least one exercise;
receiving from the subscriber a selection of the at least one person as an instructor;
receiving from the subscriber a selection of an exercise of the at least one exercise demonstrated by the instructor; and
making available and viewable by the subscriber at least one entertainment video before, during, or after the subscriber mimics the exercise demonstrated by the instructor.

2. The method of claim 1, wherein the at least one entertainment video includes at least one of a behind-the-scenes video and a licensed broadcast.

3. The method of claim 1, wherein the at least one person qualified to perform the at least one exercise includes professional athletes, celebrities, and trained amateurs.

4. The method of claim 1, wherein the at least one exercise video is curated using the theory of functional movement.

5. A microprocessor executable method of providing a fitness and entertainment platform to a subscriber, the method comprising:
making available at least one exercise video viewable by a subscriber on a video device, the at least one exercise video demonstrating at least one exercise performed by at least one person qualified to perform the at least one exercise;
making available at least one entertainment video viewable by a subscriber on a video device, the at least one entertainment video featuring the at least one qualified person;
receiving from the subscriber a selection of the at least one person as an instructor;
receiving from the subscriber a selection of an exercise of the at least one exercise demonstrated by the qualified person; and
receiving from the subscriber a selection of an entertainment video featuring the qualified person.

6. The method of claim 5, wherein the at least one exercise video is curated for the purpose of sport-specific performance training.

7. The method of claim 6, wherein the sport-specific purpose training includes skills instructions and associated drills.

8. A fitness subscription program system, comprising:
a server, wherein the server stores (a) a series of microprocessor-executable exercise videos featuring at least one qualified person to demonstrate an exercise routine, and (b) at least one microprocessor-executable entertainment video featuring the qualified person; and
processor-executable instructions that, when executed by a portable device, enable the portable device to perform a method comprising the steps of (c) presenting visual and/or aural information from the microprocessor-executable exercise video and entertainment video from the server through wireless transmission, and (d) recording data relating to the subscriber mimicking the exercise routine.

9. The system of claim 8, further comprising virtual reality equipment for displaying, transmitting, and recording all microprocessor-executable data.
